(19) United States
(12) Patent Application Publication
(10) Pub. No.: US 2002/0178033 A1
(43) Pub. Date: Nov. 28, 2002

(54) Automobile insurance contents setting system, automobile insurance premium setting system, and automobile insurance premium collection system

(76) Inventors: Tatsuo Yoshioka, Tokyo (JP); Akio Ito, Tokyo (JP); Tomohiro Umezawa, Kawasaki (JP); Jun Futamura, Kawasaki (JP)

Correspondence Address: HOGAN & HARTSON L.L.P., 500 S. GRAND AVENUE, SUITE 1900, LOS ANGELES, CA, 90071-2611, US

(21) Appl. No.: 10/099,903

(22) Filed: Mar. 13, 2002

(30) Foreign Application Priority Data
Mar. 27, 2001 (JP) 2001-089178
Sep. 6, 2001 (JP) 2001-269821

(51) Int. Cl. G06F 17/60

(52) U.S. Cl. 705/4

(57) ABSTRACT

An automobile insurance premium setting system is provided in which a premium amount may be appropriately set according to driving states of an insurant's automobile. A basic premium calculated based upon coverage and indemnity specified by the insurant, and an additional premium estimated based upon driving behavior submitted by the insurant are added and collected as a provisional premium. Driving behavior points are counted each time when actual driving behavior of the insurant deviates from criteria determined based upon the driving behavior. Safe driving points are counted each time when the actual driving behavior deviates from safe driving criteria submitted to the insurant in advance. The driving behavior points and the safe driving points are combined into demerit points, to calculate an actual additional premium corresponding to the demerit points, and a difference between the estimated additional premium and the actual additional premium is balanced upon expiration of the automobile insurance.

### BACKGROUND OF THE INVENTION

This invention relates to automobile insurance systems, and more particularly to an automobile insurance contents setting system, automobile insurance premium setting system, and automobile insurance premium collection system, in which the premiums are calculated based upon driving behavior and driving conditions of the insured.

Drivers buy automobile insurance or automobile liability insurance, mandatory or voluntary, for public liability, property damage and personal injuries, as well as accident insurance, to provide for possible accidents in relation to his/her own automobile. Mandatory insurance is to be taken out, for example, at the same regular intervals as a compulsory automobile inspection is conducted; voluntary insurance for bodily injury and property damage liabilities, and other losses or damages may typically be taken out, for example, once a year. Most insurance arrangements (premiums payable) are inexpensive and thus payment is made without payback.

Premiums are payable upon purchase of automobile insurance on a flat-rate basis without variation according to the insurance contents or other factors, with the exception of no-claim bonus or reduced amounts of premiums based upon accident-free and no-penalty-point periods. In addition, the premiums are collected in a lump sum in that the payment is made without payback.

The automobile insurance premiums as described above are paid with accident additions and no-accident deductibles calculated respectively on a specific rate and specified time period basis for each automobile. In case where automobile insurance is newly taken out upon purchase of a new automobile or upon change of an insurance company, automobile insurance premiums are set without individual evaluation based upon an insurant's past history.

However, the automobile insurance works when an accident occurs in actuality, and is not recognized as necessary until the occurrence of the accident. No insurant is willing to cause an accident. Moreover, every driver has his/her own manner of driving; i.e., some caused a lot of accidents (and thus would likely cause another), some are habitual speed demons, and some brake suddenly with frightening frequency. Further, each driver drives in a variety of situations; i.e., some drive an automobile only for commutation to and from work, some drive an automobile only during night hours, and some drive an automobile only in extremely little-trafficked areas such as farm roads. Although the conditions that affect driving of an automobile vary, premiums of insurance on the automobile are evaluated on one and the same basis.

Moreover, an actual automobile insurance fulfillment ratio shows that a driver having better driving behavior and a driver under easier driving conditions would hardly cause an accident and thus an accident occurrence ratio is lower in reality. Accordingly, the accident occurrence ratio of automobiles is higher when drivers having worse driving behavior drive under harder driving conditions, and the same goes for the automobile insurance fulfillment ratio. These circumstances disadvantageously entail imbalance upon purchase of automobile insurance under a conventional insurance premium setting scheme in which premiums are set without variation.

Furthermore, the premiums of automobile insurance are collected in a lump sum, and thus it is disadvantageously difficult to collect the premiums according to driver's driving behavior and safe driving probability.

### SUMMARY OF THE INVENTION

Therefore, it is an exemplified object of the present invention to provide an automobile insurance contents setting system in which contents of insurance may be appropriately set according to driving behavior of an insurant, and a premium may be appropriately set according to the driving behavior of the insurant.

An another exemplified object of the present invention is to provide an automobile insurance contents setting system in which contents of insurance may be appropriately set according to a driving condition of an insurant's automobile, and a premium may be appropriately set according to the driving condition of the insurant's automobile.

A yet another exemplified object of the present invention is to provide an automobile insurance premium setting system in which a premium may be appropriately set according to driving states of an insurant's automobile.

A yet another exemplified object of the present invention is to provide an automobile insurance premium collecting system in which a premium may be appropriately collected according to driving states of an insurant's automobile.

According to one aspect of the present invention, there is provided an automobile insurance contents setting system that is configured to: request an insurant to submit his/her driving behavior, based upon an application for automobile insurance for which the insurant has specified coverage and indemnity; evaluate the driving behavior submitted by the insurant; and calculate a premium of the automobile insurance in accordance with the evaluated driving behavior of the insurant.

In another aspect of the present invention, there is provided an automobile insurance contents setting system that is configured to perform the steps of: entering insurance contents into an insurant database, based upon an application for automobile insurance for which an insurant has specified coverage and indemnity; requesting the insurant to submit his/her driving behavior; receiving and entering into the insurant database the driving behavior of the insurant submitted by the insurant; making an evaluation of the driving behavior of the insurant; entering the evaluation of the driving behavior of the insurant into the insurant database; calculating and entering into the insurant database a premium of the automobile insurance in accordance with the evaluation of the driving behavior of the insurant; submitting the calculated premium to the insurant; charging the premium in the insurant database to the insurant, based upon the application for automobile insurance; and entering a conclusion of a contract of the automobile insurance into the insurant database based upon payment of the premium by the insurant.

Preferably, the above driving behavior of the insurant may include a driving history of the insurant, a traffic violation record of the insurant, a traffic accident record of the insurant, and a total distance driven by the insurant.

In still another aspect of the present invention, there is provided an automobile insurance contents setting system that is configured to: request an insurant to submit his/her driving condition, in response to an application for automobile insurance for which the insurant has specified coverage and indemnity; evaluate the driving condition submitted by the insurant, based upon the application for automobile insurance; and calculate a premium of the automobile insurance in accordance with the evaluated driving condition of the insurant.

In still another aspect of the present invention, there is provided an automobile insurance contents setting system that is configured to perform the steps of: entering insurance contents into an insurant database, based upon an application for automobile insurance for which an insurant has specified coverage and indemnity; requesting the insurant to submit his/her driving condition; receiving and entering into the insurant database the driving condition of the insurant submitted by the insurant; making an evaluation of the driving condition of the insurant; entering the evaluation of the driving condition of the insurant into the insurant database; calculating and entering into the insurant database a premium of the automobile insurance in accordance with the evaluation of the driving condition of the insurant; submitting the calculated premium to the insurant; charging the premium in the insurant database to the insurant, based upon the application for automobile insurance; and entering a conclusion of a contract of the automobile insurance into the insurant database based upon payment of the premium by the insurant.

Preferably, the above driving condition of the insurant may include a limited time of day to the night hours during which the insurant drives an automobile, a level of maintenance conditions of the automobile, the number of occurrences of engine trouble of the automobile, the number of repairs of the automobile, an area in which the insurant principally drives the automobile, and a dedicated use of the automobile to commutation to and from work.

In still another aspect of the present invention, there is provided an automobile insurance premium setting system that is configured to: calculate a basic premium, based upon an application for automobile insurance for which an insurant has specified coverage and indemnity, the basic premium being invariably determined in accordance with the indemnity of the automobile insurance; request the insurant to submit his/her driving behavior; estimate an additional premium based upon the driving behavior submitted by the insurant; provisionally collect a premium payable calculated by adding the basic premium and the additional premium; determine driving behavior points and safe driving points, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and combine the driving behavior points and the safe driving points into demerit points to calculate an actual additional premium corresponding to the demerit points, and balance a difference between the estimated additional premium and the actual additional premium upon expiration of the automobile insurance.

In still another aspect of the present invention, there is provided an automobile insurance premium setting system that is configured to perform the steps of: entering insurance contents into an insurant database based upon an application for automobile insurance for which an insurant has specified coverage and indemnity by selecting among coverages and indemnities stored in an automobile insurance contents database; calculating and entering into the insurant database a basic insurance premium that is invariably determined in accordance with the indemnity of the automobile insurance; estimating and entering into the insurant database an additional premium based upon driving behavior submitted by the insurant; provisionally collecting a premium payable calculated by adding the basic premium and the additional premium, and entering the premium payable into a premium payment database; determining driving behavior points and safe driving points in accordance with determination criteria stored in a driving behavior/safe driving determination database and entering the driving behavior points and safe driving points into the insurant database, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and combining the driving behavior points and the safe driving points into demerit points to calculate an actual additional premium corresponding to the demerit points, and entering the actual additional premium into the insurant database to balance a difference between the estimated additional premium and the actual additional premium upon expiration of the automobile insurance.

In still another aspect of the present invention, there is provided an automobile insurance premium setting system that is configured to: calculate a basic premium, based upon an application for automobile insurance for which an insurant has specified coverage and indemnity, the basic premium being invariably determined in accordance with the indemnity of the automobile insurance; request the insurant to submit his/her driving behavior; estimate an additional premium based upon the driving behavior submitted by the insurant; collect a premium payable calculated by adding the additional premium as a deposit to the basic premium; determine driving behavior points and safe driving points periodically, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and combine the driving behavior points and the safe driving points into demerit points to calculate an actual additional premium corresponding to the demerit points, and subtract the actual additional premium from the estimated additional premium periodically.

In still another aspect of the present invention, there is provided an automobile insurance premium setting system that is configured to perform the steps of: entering insurance contents into an insurant database, based upon an application for automobile insurance for which an insurant has specified coverage and indemnity by selecting among coverages and indemnities stored in an automobile insurance contents database; calculating and entering into the insurant database a basic insurance premium that is invariably determined in accordance with the indemnity of the automobile insurance; estimating and entering into the insurant database an additional premium based upon the driving behavior submitted by the insurant; collecting a premium payable calculated by adding the additional premium as a deposit to the basic premium, and entering the premium payable into a premium payment database; determining driving behavior points and safe driving points periodically in accordance with determination criteria stored in a driving behavior/safe driving determination database and entering the driving behavior points and safe driving points into the insurant database, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and combining the driving behavior points and the safe driving points into demerit points periodically to calculate an actual additional premium corresponding to the demerit points, and entering the actual additional premium into the insurant database.

Preferably, the above driving behavior points may concern speeding, abrupt braking, abrupt steering, abrupt acceleration, and zigzagging. Preferably, the above safe driving points may concern traffic accidents, traffic violations, neglecting periodical automobile inspections, and long-sustained driving.

In another aspect of the present invention, there is provided an automobile insurance premium collection system that is configured to: collect a premium payable estimated by adding a basic premium and an additional premium, the basic premium being determined from coverage and indemnity that have been specified by an insurant, and the additional premium being determined based upon driving behavior submitted by the insurant in advance; add a first premium incurred if actual driving behavior of the insurant deviates from driving behavior criteria determined based upon the driving behavior specified by the insurant and a second premium incurred if the actual driving behavior of the insurant deviates from safe driving criteria submitted to the insurant in advance; and add the first and second premiums as an actual additional premium to the basic premium to obtain an actual premium payable, balancing a difference between the estimated premium payable and the actual premium payable, upon expiration of the automobile insurance.

In another aspect of the present invention, there is provided an automobile insurance premium setting system that is configured to: collect a basic premium determined based upon coverage and indemnity of insurance that have been specified by an insurant; estimate an additional premium based upon driving behavior of the insurant submitted by the insurant; collect the additional premium as a deposit; add a first premium incurred if actual driving behavior of the insurant deviates from driving behavior criteria determined based upon the driving behavior specified by the insurant and a second premium incurred if the actual driving behavior of the insurant deviates from safe driving criteria submitted to the insurant in advance; and periodically collect the first and second premiums from the additional premium collected as a deposit.

In another aspect of the present invention, there is provided an automobile insurance premium setting system that is configured to: collect a basic premium determined based upon coverage and indemnity of insurance that have been specified by an insurant; estimate an additional premium based upon driving behavior of the insurant submitted by the insurant in advance; collect the additional premium as a deposit; and grant safety driving points if actual driving behavior of the insurant fulfills driving behavior criteria determined based upon the driving behavior submitted by the insurant in advance and if the actual driving behavior of the insurant fulfills safe driving criteria submitted to the insurant in advance.

Other objects and further features of the present invention will become readily apparent from the following description of preferred embodiments with reference to accompanying drawings.

### BRIEF DESCRIPTION OF THE DRAWINGS

FIG. 1 illustrates a general infrastructure for implementation of an automobile insurance contents setting system according to the present invention, with information transmit/receive flow indicated.

FIG. 2 is a system chart of an exemplified embodiment of an automobile insurance contents setting system according to the present invention, in which a terminal unit of an insurance service using member is utilized.

FIG. 3 is a system chart of an exemplified embodiment of an automobile insurance contents setting system, automobile insurance premium setting system, and automobile insurance premium collection system according to the present invention, in which automobile-installed terminal unit (in-vehicle equipment) of an insurance service using member is utilized.

FIG. 4 is a system chart of an exemplified embodiment of an automobile insurance contents setting system, automobile insurance premium setting system, and automobile insurance premium collection system according to the present invention, in which automobile-installed terminal unit (in-vehicle equipment) of an insurance service using member is utilized.

FIG. 5 is a system chart of an exemplified embodiment of an automobile insurance contents setting system, automobile insurance premium setting system, and automobile insurance premium collection system according to the present invention, in which automobile-installed terminal unit (in-vehicle equipment) of an insurance service using member is utilized.

FIG. 6 is a system chart of an exemplified embodiment of an automobile insurance contents setting system, automobile insurance premium setting system, and automobile insurance premium collection system according to the present invention, in which automobile-installed terminal unit (in-vehicle equipment) of an insurance service using member is utilized.

FIG. 7 is a system chart of an exemplified embodiment of an automobile insurance contents setting system, automobile insurance premium setting system, and automobile insurance premium collection system according to the present invention, in which automobile-installed terminal unit (in-vehicle equipment) of an insurance service using member is utilized.

FIG. 8 is a schematic block diagram that illustrates a configuration of in-vehicle equipment of an automobile owned by an insurance service using member.

FIG. 9 is an operation flowchart showing a communication process performed between an insurance service using member and an insurance service provider during registration for membership.

FIG. 10 is an operation flowchart of a process performed by an insurance service using member when the insurant member buys automobile insurance.

FIG. 11 is an operation flowchart of a process performed by an insurance service provider when the insurance service using member buys automobile insurance.

FIG. 12 is an operation flowchart showing a process of collecting automobile insurance premiums performed by an insurance service provider that has concluded an automobile insurance contract with an insurance service using member.

FIG. 13 illustrates an exemplified on-screen representation of a membership registration application message to an insurance service user.

FIG. 14 illustrates an exemplified on-screen representation of an individual information input form displayed upon application for membership registration of an insurance service user.

FIG. 15 illustrates an exemplified on-screen representation of a notification of completed membership registration of an insurance service user.

FIG. 16 illustrates an exemplified on-screen representation of a confirmation of an application for automobile insurance by an insurance service user.

FIG. 17 illustrates an exemplified on-screen representation of a vehicle information input form to be filled in by an insurance service user to specify particulars of an automobile for which insurance is to be bought.

FIG. 18 illustrates an exemplified on-screen representation of an automobile insurance contents input form to be filled in by an insurance service user to specify particulars of automobile insurance.

FIG. 19 illustrates an exemplified on-screen representation of a driving behavior input form to be filled in by an insurance service user.

FIG. 20 illustrates an exemplified on-screen representation of a driving condition input form to be filled in by an insurance service user.

FIG. 21 illustrates an exemplified on-screen representation of a total sum of premiums payable of automobile insurance.

FIG. 22 illustrates an exemplified on-screen representation of a detailed list of demerit points as shown in FIG. 21.

FIG. 23 illustrates another exemplified on-screen representation of the total sum of premiums payable of automobile insurance.

FIG. 24 illustrates an exemplified on-screen representation of an invitation to pay automobile insurance premiums.

FIG. 25 illustrates an exemplified on-screen representation showing a notification of completion of an insurance contract procedure for automobile insurance.

FIG. 26 illustrates an exemplified on-screen representation of a notification showing total points for calculating an additional premium of premiums payable for automobile insurance, and sum of money corresponding thereto.

FIG. 27 illustrates an exemplified on-screen representation of a detailed list of demerit points as shown in FIG. 26.

FIG. 28 illustrates another exemplified on-screen representation of a notification showing total points for calculating an additional premium of premiums payable for automobile insurance, and sum of money corresponding thereto.

FIG. 29 is a block diagram showing a configuration of a processor in an insurance service provider.

FIG. 30 illustrates membership registration cards for insurance service using members.

### DETAILED DESCRIPTION OF THE PREFERRED EMBODIMENTS

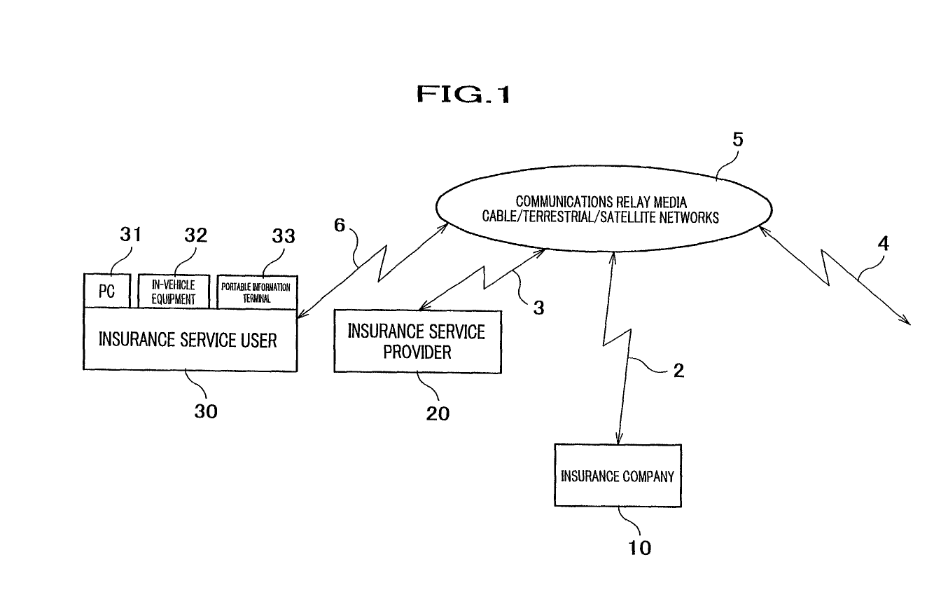

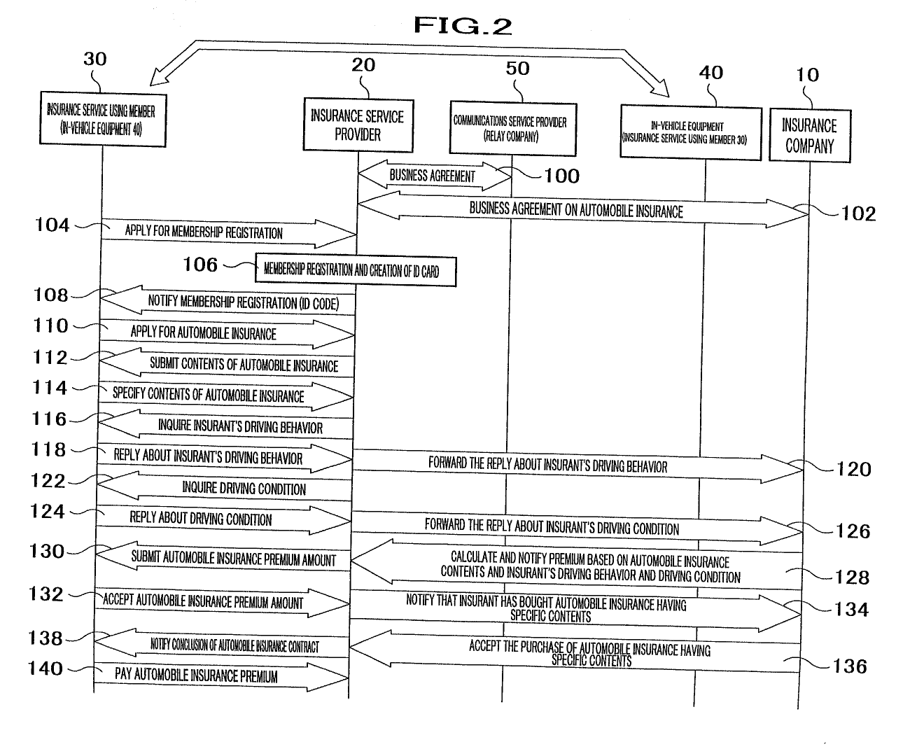

FIG. 1 shows a general infrastructure for implementation of an automobile insurance contents setting system according to the present invention, with information transmit/receive flow indicated. FIG. 2 shows an exemplified embodiment of the automobile insurance contents setting system.

In the drawings, an insurance service provider (or insurance service providing company) 20 provides an insurance contract service to an insurance service user 30. The insurance service provider 20 has a business alliance agreement with an insurance company 10 in connection with insurance provided to the insurance service user 30.

The insurance company 10 transmits information on insurance to the insurance service provider 20. The information may be transmitted through a public network. A satellite communication may be used for transmission of the information, as well as cable and terrestrial communications networks. It is conceivable as an example of simple methods of transmitting information on insurance from the insurance company to the insurance service provider 20 that available insurance information could be transmitted from the insurance company via a line 2 to communications relay media 5 that utilizes communications satellites, and then from the communications relay media via a line 3 to the insurance service provider 20. The insurance company 10 has an agreement with the insurance service provider 20 to provide an available insurance product lineup of the insurance company 10 to the insurance service provider 20 as described above.

The insurance service provider 20 that has received the insurance product lineup from the insurance company 10 transmits information on some preferred insurance products at the request of the insurance service user 30 via the line 3, to the communications relay media (e.g., communications satellites) 5, and then via a line 6 to a PC 31, in-vehicle equipment 32, portable information terminal 33, or the like owned by the insurance service user 30. The in-vehicle equipment 32 includes a mechanism for determining a position of the automobile using radio waves from a plurality of GPS satellites, and communicates with the insurance service provider 20 via the line 6, communications relay media (e.g., communications satellites) 5, and line 3 to transmit acquired positioning information to the insurance service provider 20.

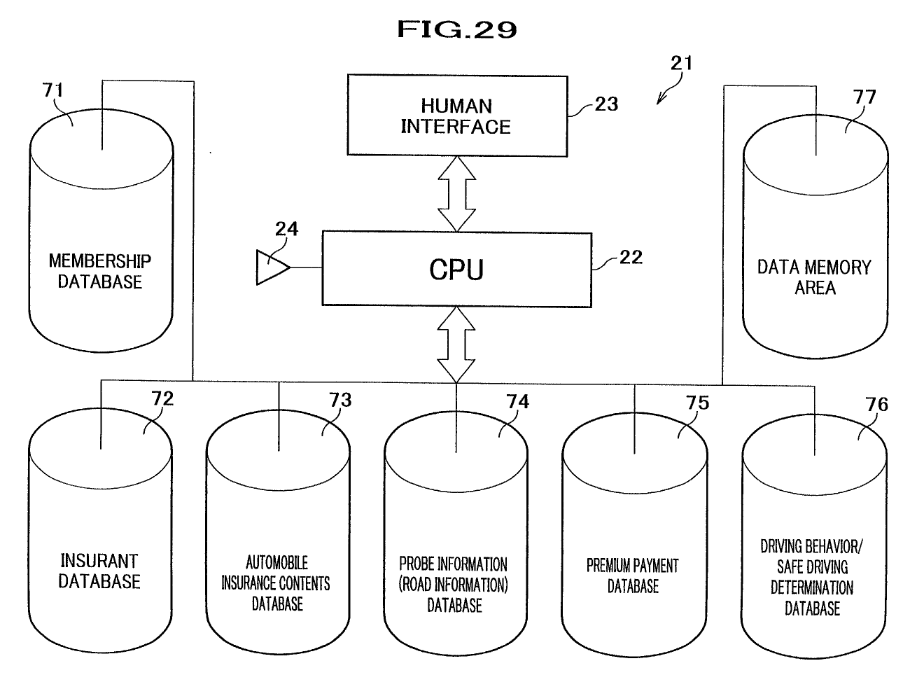

The insurance service provider 20 has a processor 21 as shown in FIG. 29. The processor 21 includes a CPU 22, which performs every operation of the processor 21. To the CPU 22 is connected a human interface 23 via a bus line. In addition, a storage device including a variety of databases is connected to the CPU via a bus line. The human interface 23 allows a user to operate the processor 21 to perform various operations (e.g., writing and reading data). Denoted by 24 is an antenna, which serves to enable the insurance service provider 20 to communicate with the insurance service user 30 having a PC 31, in-vehicle equipment 32, portable information terminal 33, or the like, and the insurance company 10 via a communications service provider 50. The storage device includes a membership database 71, an insurant database 72, an automobile insurance contents database 73, a probe information (road information) database 74, a premium payment database 75, a driving behavior/safe driving determination database 76, and a data memory area 77.

The membership database 71 contains individual data of members using automobile insurance services (e.g., insurants) in the form of database records, of which fields include a name, age, occupation, date of birth, month and year of grant for driver's license (or expiration date), vehicle information, traffic accident record, traffic violation record, family makeup, contact address, etc. of the individual members.

The insurant database 72 contains individual data of members who have bought automobile insurance in the form of database records, of which fields include a coverage (e.g., personal injury liability, property damage liability, owner's self damage, passenger's damage, driver-specific coverage, and driver's age limit), indemnity (e.g., unlimited, up to a specific sum, owner only, and over a specific age), basic premium amount, additional premium amount, premium payable amount, and extra premium amount per point for driving behavior points and safe driving points, etc. of the insurance.

The probe information (road information) database 74 contains information on types of roads on which the vehicle drives (e.g., unpaved, gradient, serpentined, etc.), and information on conditions of road surfaces (e.g., gravel road, freezing road, etc.) in the form of database records.

The premium payment database 75 contains premiums paid by the members who have bought automobile insurance in the form of database records; the premiums include a basic premium paid by the members who have bought automobile insurance, an additional premium paid by the members who have bought automobile insurance, and a total sum of premiums paid by the members who have bought automobile insurance.

The driving behavior/safe driving determination database 76 contains criteria for determining driving behavior (e.g., speeding, abrupt braking, abrupt steering, abrupt acceleration, and zigzagging) to count driving behavior points used to add or subtract corresponding sums to or from the additional premium in the form of database records. In addition, the driving behavior/safe driving determination database 76 contains criteria for determining safe driving negligence (e.g., traffic accidents, traffic violations, neglecting periodical automobile inspections, and long-sustained driving) to count safe driving points used to add or subtract corresponding sums to or from the additional premium in the form of database records.

The data memory area 77 serves to temporarily retain each piece of information that is sent from the PC 31, in-vehicle equipment 32, portable information terminal 33, or the like owned by the member who is buying automobile insurance (insurance service user) 30.

In FIG. 2, the insurance service provider 20 makes a business agreement with the communication service provider 50 to utilize public networks, satellites, and the like (100) so that the insurance service provider 20 may communicate with the insurance company 10 and the insurance service user 30 (in-vehicle equipment 40).

Moreover, the insurance service provider 20 makes a business agreement with the insurance company 10 on provision of insurance product information (102).

The insurance service provider 20 accepts an application for an automobile insurance membership registration from a person who wishes to buy automobile insurance provided by the insurance company 10 (104). Then, the insurance service provider 20 records necessary individual data of the person who has submitted the application (applicant), and performs a membership registration process. The membership registration process includes determining a PIN code (ID number) as a membership number, creating a card (e.g., an ID card, or an IC card capable of recording input information on an embedded IC chip and reading the recorded information thereon) as a membership card (106), and notifying the applicant of completion of a membership registration (e.g., issuing the ID card) (108). Although a description has been given herein of the membership card as exemplified by the ID card and IC card, any portable media capable of storing individual information for identifying each member and utilization information of the member, such as a multi-functional card, as well as the ID card and the IC card, may be used.

The thus-registered insurance service using member 30 may apply for automobile insurance to the insurance service provider 20 at any time. When the insurance service using member 30 applies for automobile insurance to the insurance service provider 20 (110), the insurance service provider 20 submits contents (coverages and indemnities) of the automobile insurance (112) to the insurance service using member 30. The insurance service using member 30 then reviews the contents of the automobile insurance, and specifies a preferred combination of the contents of the automobile insurance (114). Next, the insurance service provider 20 inquires driving behavior of the insurance service using member 30 (116). To be more specific, the insurance service provider 20 requests the insurance service using member 30 to submit his/her driving behavior (e.g., a driving history such as a traffic violation record including speeding, a driving record including abrupt braking, abrupt steering, abrupt acceleration and zigzagging, and a traffic accident record, as well as a total distance driven). In response to the inquiry, the insurance service using member 30 submits the driving behavior to the insurance service provider 20. More specifically, the insurance service using member 30, who has been requested to disclose his/her driving behavior, replies to each particular query about the driving behavior furnished by the insurance service provider 20 (118). The reply about the driving behavior submitted by the insurance service using member 30 to the insurance service provider 20 is forwarded from the insurance service provider 20 to the insurance company 10 (120). The insurance company 10, who has received from the insurance service provider 20 the reply about the driving behavior of the insurance service using member 30, evaluates the driving behavior to calculate premiums as reflected by the driving behavior.

Alternatively or optionally, when the insurance service using member 30 specifies the contents of the automobile insurance, the insurance service provider 20 inquires a driving condition of the insurance service using member 30 who has applied for the automobile insurance (122). To be more specific, the insurance service provider 20 requests the insurance service using member 30 to submit his/her driving condition (e.g., limitations on time of day of driving to the night hours, on area of driving to little-trafficked area, and on purpose of driving to commutation to and from work; a level of maintenance conditions of the automobile such as a periodical inspection implementation ratio; and the number of occurrences of engine trouble and the number of repairs in the past, as well as the date of manufacture of the automobile). In response to the inquiry, the insurance service using member 30 submits the driving condition to the insurance service provider 20. More specifically, the insurance service using member 30, who has been requested to disclose his/her driving condition, replies to each particular query about the driving condition furnished by the insurance service provider 20 (124). The reply about the driving condition submitted by the insurance service using member 30 to the insurance service provider 20 is forwarded from the insurance service provider 20 to the insurance company 10 (126). The insurance company 10, who has received from the insurance service provider 20 the reply about the driving condition of the insurance service using member 30, evaluates the driving condition to calculate premiums as reflected by the driving condition.

The insurance company 10 uses the evaluation of the driving behavior and/or driving condition made by the insurance company 10, to calculate a premium payable based upon the automobile insurance contents and the automobile insurant's driving behavior and driving condition, and notifies the insurance service provider 20 of the resultant premium payable (128). The insurance service provider 20 then submits the premium amount of the automobile insurance calculated by the insurance company 10 to the insurance service using member 30 as an applicant, and charges the insurance service using member 30 for the premium (130). If the insurance service using member 30 accepts the premium payable of the automobile insurance calculated by the insurance company 30 and submitted by the insurance service provider 20 (132), the insurance service provider 20 notifies the insurance company 10 that the insurance service using member 30 has bought the automobile insurance having specific contents (134). Having received the notification from the insurance service provider 20, the insurance company 10 notifies the insurance service provider 20 that the insurance company 10 accepts the purchase of the automobile insurance having specific contents by the insurance service using member 30 (136). The insurance service provider 20, who has received the notification of acceptance from the insurance company 10, notifies the insurance service using member 30 that an automobile insurance contract has been concluded (138). In response to the notification of the conclusion of the automobile insurance contract from the insurance service provider 20, the insurance service using member 30 pays the premium of the automobile insurance to the insurance service provider 20 (140). When the payment of the premium from the insurance service using member 30 to the insurance service provider 20 is confirmed, the premium is entered into the membership card. The entry of the premium into the membership card entitles the insurance service using member 30 to receive a specific insurance service from the insurance company 10.

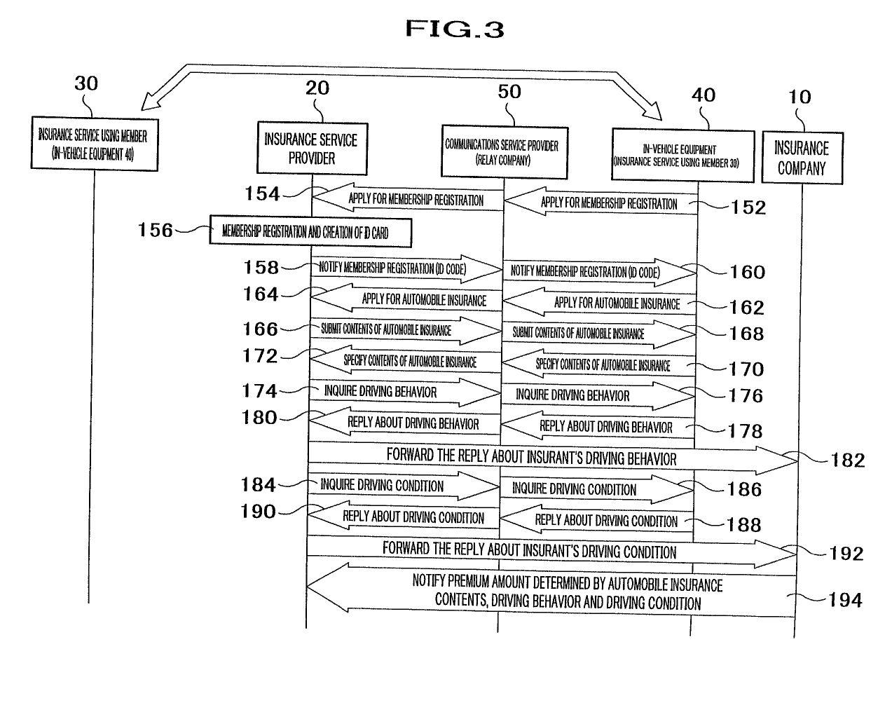

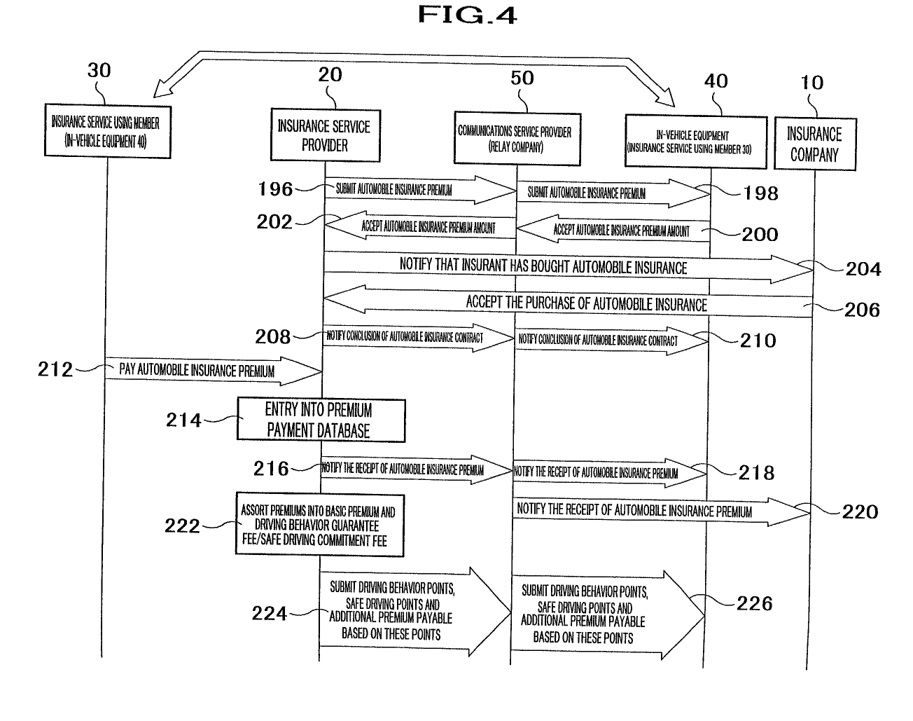

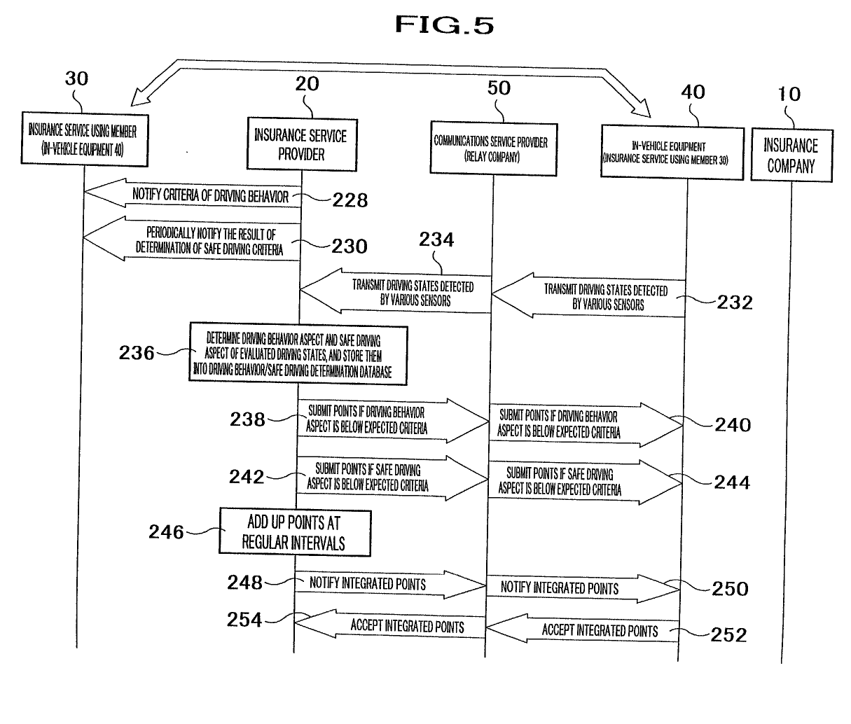

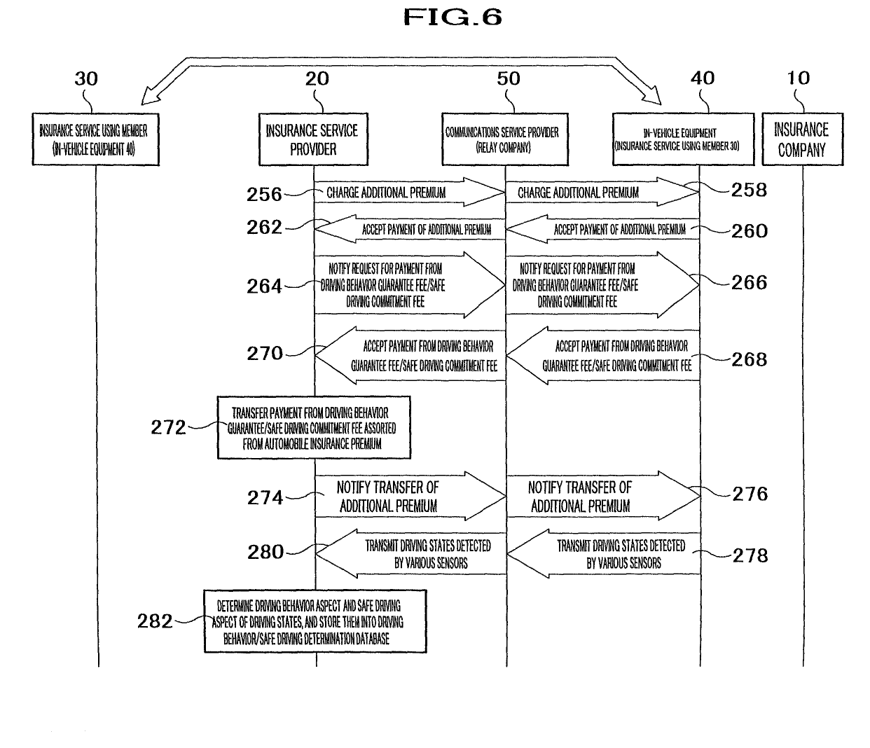

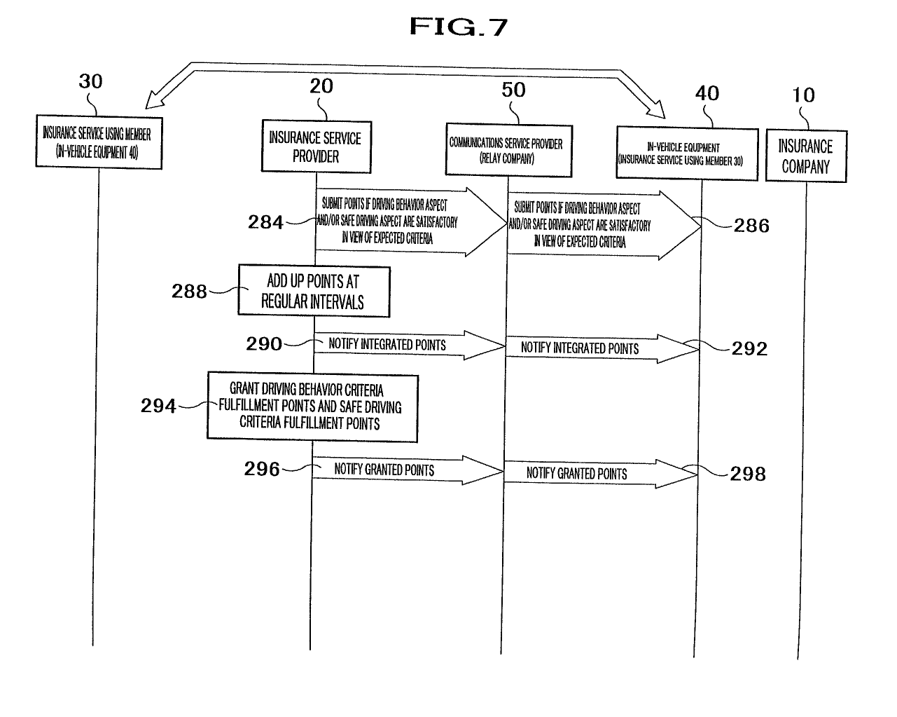

The in-vehicle equipment 40 in the automobile used by the insurance service using member 30 may be enabled upon insertion of an IC card or other types of membership card to communicate with the insurance service provider 20 via the communication service provider 50. FIGS. 3 through 7 show an exemplified embodiment of the automobile insurance contents setting system, automobile insurance premium setting system, and automobile insurance premium collection system using the in-vehicle equipment 40 in the automobile.

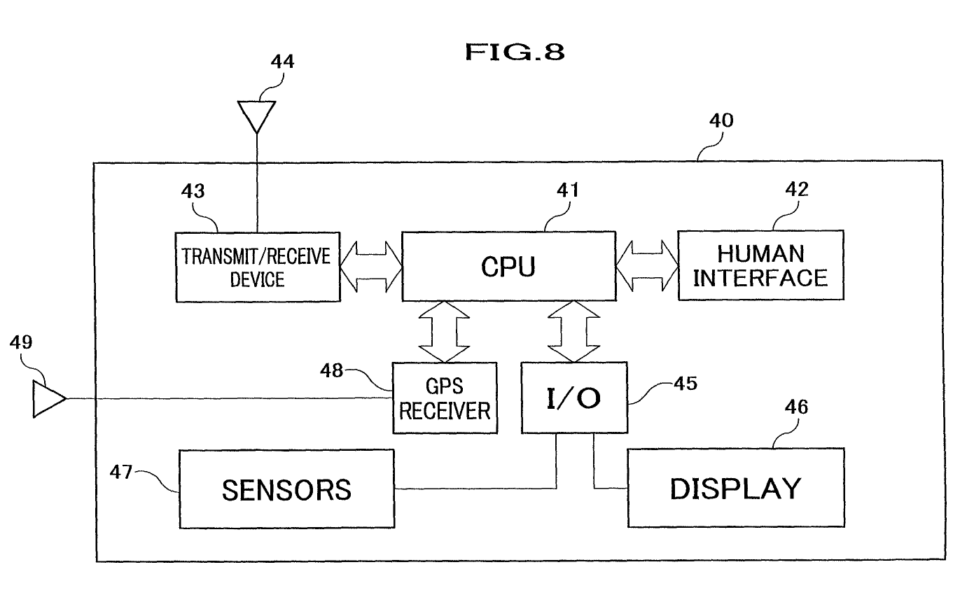

The in-vehicle equipment 40 that is owned by the insurance service using member 30 is configured as shown in FIG. 8. To be more specific, the in-vehicle equipment 40 includes a CPU 41, which performs every operation thereof. To the CPU 41 is connected a human interface 42 via a bus line. In addition, a transmit/receive device 43 is connected to the CPU 41 via a bus line. The human interface 42 allows a user to operate the in-vehicle equipment 40 to perform various operations (e.g., writing and reading data). The transmit/receive device 43 conducts communications via an antenna 44, to transmit data or the like input through the human interface 42, and to receive data sent from the insurance service provider 20. To the CPU 41 is connected an I/O 45 via a bus line. To the I/O 45 are connected data or the like input through the human interface 42, a display 46 to display data received from the insurance service provider 20, and various types of sensors 47 such as a speed sensor, a vehicle speed sensor, a rainfall sensor, an illumination sensor, an engine temperature sensor, an engine revolution sensor, a headlight/fog detector lamp lighting sensor, a room temperature sensor, etc. Moreover, to the CPU 41 is connected a GPS receiver 48, which is designed to receive positioning signals from GPS satellites via an antenna 49.

A description will now be given of an exemplified embodiment of the present invention in details with reference to the system chart shown in FIGS. 3 through 6. First, the insurance service provider 20 accepts an application for registration of an automobile insurance membership from a person who wishes to buy automobile insurance provided by the insurance company 10, which application is submitted from the in-vehicle equipment 40 (152), and relayed via the communication service provider 50 to the insurance service provider 20 (154). Having received the application from the in-vehicle equipment 40 of the insurance service using member 30, the insurance service provider 20 records necessary individual data of the person who has submitted the application (applicant), and performs a membership registration process. The membership registration process includes determining a PIN code (ID number) as a membership number, creating a card (e.g., an ID card, or an IC card capable of recording input information on an embedded IC chip and reading the recorded information thereon) as a membership card (156), and notifying the applicant of completion of a membership registration, for example, by transmitting such notification via the communication service provider 50 to the in-vehicle equipment 40 while issuing the ID card (158, 160). It is to be understood that the ID card may be issued and delivered to the applicant by mail or other means in the instant case where the application is transmitted from the in-vehicle equipment 40. Although a description has been given herein of the membership card as exemplified by the ID card and IC card, any portable media capable of storing individual information for identifying each member and utilization information of the member, such as a multi-functional card, as well as the ID card and the IC card, may be used.

The thus-registered insurance service using member 30 may apply for automobile insurance to the insurance service provider 20 at any time, and an application for automobile insurance may be submitted from the in-vehicle equipment 40 via the communication service provider 50 (162, 164). When the insurance service using member 30 applies for automobile insurance to the insurance service provider 20, the insurance service provider 20 submits contents (coverages and indemnities) of the automobile insurance in return via the communication service provider 50 to the in-vehicle equipment 40 of the insurance service using member 30 (166, 168). The insurance service using member 30 then reviews the contents of the automobile insurance, and specifies a preferred combination of the contents of the automobile insurance from the in-vehicle equipment 40 via the communication service provider 50 (170, 172). Next, the insurance service provider 20 makes an inquiry about driving behavior of the insurance service using member 30 which inquiry is submitted through the communication service provider 50 to the in-vehicle equipment 40 of the insurance service using member 30 (174, 176). To be more specific, the insurance service provider 20 requests the insurance service using member 30 to submit his/her driving behavior. In response to the inquiry, the insurance service using member 30 submits the driving behavior to the insurance service provider 20 from the in-vehicle equipment 40 via the communication service provider 50 (178, 180). More specifically, the insurance service using member 30, who has been requested to disclose his/her driving behavior, replies to each particular query about the driving behavior furnished by the insurance service provider 20. The reply about the driving behavior submitted by the insurance service using member 30 to the insurance service provider 20 is forwarded from the insurance service provider 20 to the insurance company 10 (182). The insurance company 10, who has received from the insurance service provider 20 the reply about the driving behavior of the insurance service using member 30, evaluates the driving behavior to calculate premiums as reflected by the driving behavior.

Alternatively or optionally, following an application for automobile insurance by the insurance service using member 30 to the insurance service provider 20, the insurance service provider 20 submits contents (coverages and indemnities) of the automobile insurance to the insurance service using member 30 (166, 168); then after the insurance service using member 30 specifies a preferred combination of the contents of the automobile insurance (170, 172), the insurance service provider 20 makes an inquiry about a driving condition of the insurance service using member 30 who has applied for the automobile insurance (184, 186), where all data and instructions are transmitted via the communication service provider 50 between the insurance service provider 20 and the in-vehicle equipment 40 of the insurance service using member 30. To be more specific, the insurance service provider 20 requests the insurance service using member 30 to submit his/her driving condition. In response to the inquiry, the insurance service using member 30 submits the driving condition to the insurance service provider 20 from the in-vehicle equipment 40 through the communication service provider 50 (188, 190). More specifically, the insurance service using member 30, who has been requested to disclose his/her driving condition, replies to each particular query about the driving condition furnished by the insurance service provider 20. The reply about the driving condition submitted by the insurance service using member 30 to the insurance service provider 20 is forwarded from the insurance service provider 20 to the insurance company 10 (192). The insurance company 10, who has received from the insurance service provider 20 the reply about the driving condition of the insurance service using member 30, evaluates the driving condition to calculate premiums as reflected by the driving condition.

The insurance company 10 uses the evaluation of the driving behavior and/or driving condition made by the insurance company 10 to calculate a premium based upon the automobile insurance contents (coverage and indemnity specified by the insurant) and the automobile insurant's driving behavior and driving condition, and notifies the insurance service provider 20 of the resultant premium amount (194). The insurance service provider 20 then submits the premium amount of the automobile insurance calculated by the insurance company 10 to the insurance service using member 30 as an applicant, and charges the insurance service using member 30 for the premium, where a bill is transmitted via the communication service provider to the in-vehicle equipment of the insurance service using member 30 (196, 198). If the insurance service using member 30 accepts the premium payable of the automobile insurance calculated by the insurance company 10 and submitted by the insurance service provider 20, and transmits an acceptance message from the in-vehicle equipment through the communication service provider (200, 202), the insurance service provider 20 notifies the insurance company 10 that the insurance service using member 30 has bought the automobile insurance having specific contents (204). Having received the notification from the insurance service provider 20, the insurance company 10 notifies the insurance service provider 20 that the insurance company 10 accepts the purchase of the automobile insurance having specific contents by the insurance service using member 30 (206). The insurance service provider 20, who has received the notification of acceptance from the insurance company 10, transmits a notification through the communication service provider 50 to the in-vehicle equipment of the insurance service using member 30 that an automobile insurance contract has been concluded (208, 210). In response to the notification of the conclusion of the automobile insurance contract from the insurance service provider 20, the insurance service using member 30 pays the premium of the automobile insurance to the insurance service provider 20 (212). When the payment of the premium from the insurance service using member 30 to the insurance service provider 20 is confirmed, the premium is entered into the membership card. The entry of the premium into the membership card entitles the insurance service using member 30 to receive a specific insurance service from the insurance company 10.

When the automobile insurance contract is concluded and the insurance service using member 30 pays the specified premium to the insurance service provider 20, the premium paid by the insurance service using member 30 is stored into the premium payment database 75 in the storage device included in the processor of the insurance service provider 20 (214). When the premium paid by the insurance service using member 30 is stored into the premium payment database 75, the insurance service provider 20 transmits a notification via the communication service provider 50 to the in-vehicle equipment 40 of the insurance service using member 30 that the insurance service provider 20 has confirmed receipt of the premium paid from the insurance service using member 30 (216, 218). This notification of receipt of the premium from the insurance service using member 30 is transmitted via the communication service provider 50 to the company 10 as well (220).

After receiving the premium paid by the insurance service using member 30 and transmitting the notification of receipt of the premium to the in-vehicle equipment 40 and the insurance company 10, the insurance service provider 20 assorts the premium paid by the insurance service using member 30 into a basic premium, a driving behavior guarantee fee, and a safe driving commitment fee (222). The driving behavior guarantee fee is designed to allow an insurant member who has taken out automobile insurance to assess his/her own driving behavior and guarantee a self-assessed level of the driving behavior, and is payable as an extra premium when actual driving behavior of the insurant member deviates from criteria determined based upon the driving behavior submitted by the insurant member. The safe driving commitment fee is payable as an extra premium when the actual driving behavior of the insurant member deviates from criteria predetermined by the insurance service provider 20. The safe driving commitment fee is deposited money that would not be disbursed as a premium if safe driving criteria were fulfilled, and is designed to allow the insurant member to make a commitment to fulfill the safe driving criteria. When the insurance service provider 20 assorts the premium paid by the insurance service using member 30 into the basic premium, driving behavior guarantee fee, and safe driving commitment fee, the insurance service provider 20 submits driving behavior points and safe driving points, and an additional premium payable based upon these points via the communication service provider 50 to the in-vehicle equipment of the insurance service using member 30 (224, 226). The insurance service provider 20 not only submits the driving behavior points and safe driving points, but also notifies the insurance service using member 30 of the criteria of the driving behavior (228). Further, the insurance service provider 20 periodically notifies the insurance service using member 30 of a result of determination of the safe driving criteria (230).

On the other hand, the in-vehicle equipment 40 transmits driving states detected by various sensors 47 installed in the automobile via the communication service provider 50 to the insurance service provider 20 (232, 234). When the insurance service provider 20 receives the driving states of the automobile transmitted from the in-vehicle equipment 40, the insurance service provider 20 evaluates the driving states based upon driving behavior and safe driving criteria, and stores the evaluated driving states into the driving behavior/safe driving determination database 76 (236). If a driving behavior aspect of the evaluated driving states is unsatisfactory in view of the expected criteria of the insurance service provider 20, i.e., the driving behavior aspect is evaluated low, then driving behavior points (points for payment of an additional premium) are submitted via the communication service provider 50 to the in-vehicle equipment 40 (238, 240). Similarly, if a safe driving aspect of the evaluated driving states is unsatisfactory in view of the expected criteria of the insurance service provider 20, i.e., the safe driving aspect is evaluated low, then safe driving points (points for payment of an additional premium) are submitted via the communication service provider 50 to the in-vehicle equipment 40 (242, 244). Each value of these points is added up at regular intervals in the insurance service provider 20 (246).

The values of the points integrated in the insurance serviced provider 20 are transmitted from the insurance service provider 20 via the communication service provider 50 to the in-vehicle equipment 40 (250). If the insurance service using member 30 accepts the points transmitted from the insurance service provider 20, the acceptance of the integrated values of the points is transmitted from the in-vehicle equipment 40 via the communication service provider 50 to the insurance service provider 20 (252, 254). Based upon the acceptance of the integrated values of the points, the insurance service provider 20 charges the insurance service using member 30 for an additional premium, where a bill is transmitted from the insurance service provider 20 via the communication service provider 20 to the in-vehicle equipment 40 of the insurance service using member 30 (256, 258). Having received the bill, the insurance service using member 30 gives his/her consent to pay the additional premium from the in-vehicle equipment 40 via the communication service provider 50 to the insurance service provider 20 (260, 262). Then, the insurance service provider 20 transmits a request for payment for the bill (additional premium) from the driving behavior guarantee fee and safe driving commitment fee to the insurance service using member 30 (in-vehicle equipment 40 thereof) via the communication service provider 50 (264, 266). In response, the insurance service using member 30 gives his/her consent to the request for payment from the driving behavior guarantee fee and safe driving commitment fee, from the in-vehicle equipment 40 via the communication service provider 50 to the insurance service provider 20 (268, 270). In accordance with the consent to the requested payment from the driving behavior guarantee fee and safe driving commitment fee, the insurance service provider 20 transfers the equivalent of the additional payment from the driving behavior guarantee fee and safe driving commitment fee that are assorted out of premiums paid by the insurance service using member 30 (272). After transferring the equivalent of the additional payment from the driving behavior guarantee fee and safe driving commitment fee, the insurance service provider 20 transmits a notification of transfer of the additional premium via the communication service provider 50 to the in-vehicle equipment 40 (insurance service using member 30) (274, 276).

On the other hand, the in-vehicle equipment 40 transmits driving states detected is by various sensors 47 installed in the automobile via the communication service provider 50 to the insurance service provider 20 (278, 280). When the insurance service provider 20 receives the driving states of the automobile transmitted from the in-vehicle equipment 40, the insurance service provider 20 evaluates the driving states based upon driving behavior and safe driving criteria, and stores the evaluated driving states into the driving behavior/safe driving determination database 76 (282). If a driving behavior aspect and/or safe driving aspect of the evaluated driving states is satisfactory respectively in view of the expected criteria of the insurance service provider 20, i.e., the driving behavior aspect and/or safe driving aspect is evaluated high, then driving behavior points and safe driving points (points granted to an excellent safe driver) upon fulfillment of the criteria are submitted via the communication service provider 50 to the in-vehicle equipment 40 (284, 286). Each value of these granted points may be calculated for payment of premiums, or calculated to receive an equivalent free gift. Each value of the granted points is added up at regular intervals in the insurance service provider 20 (288).

The value of points integrated in the insurance service provider 20 is transmitted from the insurance service provider 20 via the communication service provider 50 to the in-vehicle equipment of the insurance service using member 30 (290, 292). The insurance service provider 20 who has transmitted the integrated value of points to the insurance service using member 30 (in-vehicle equipment 40 thereof) grants driving behavior criteria fulfillment points and safe driving criteria fulfillment points to the insurance service using member 30 (294). The insurance service provider 20 transmits the value of the granted points via the communication service provider 50 to the in-vehicle equipment 40 (insurance service using member 30) (298).

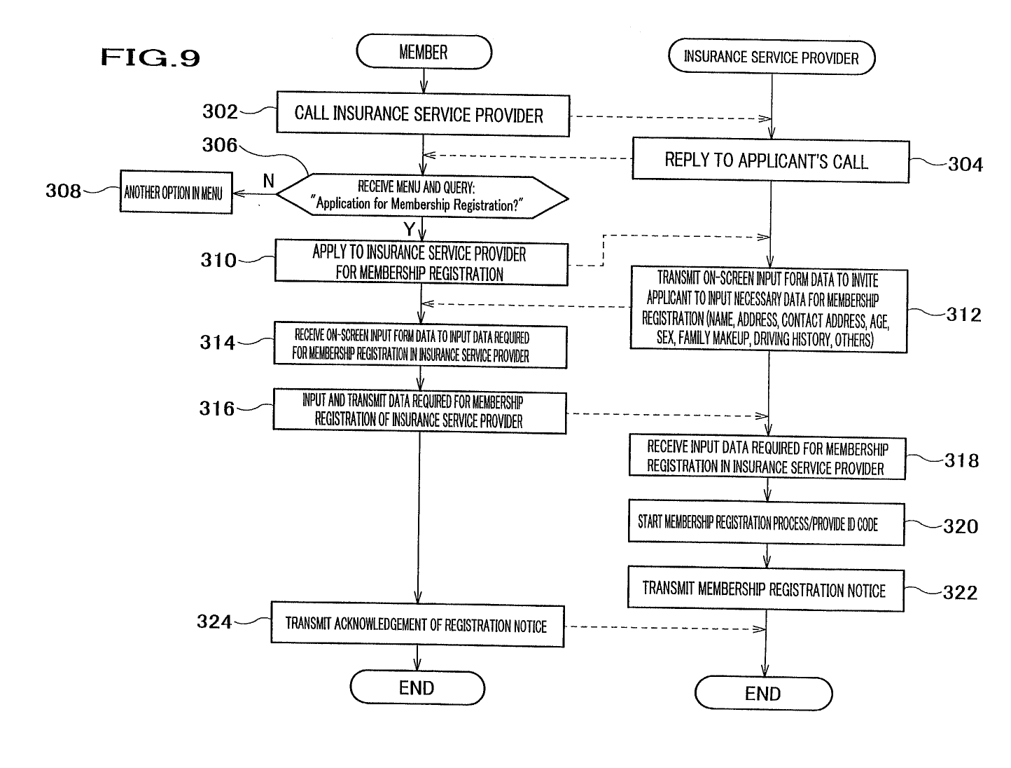

A description will now be given of a membership registration process with reference to operation flowcharts shown in FIG. 9 in which the insurance service using member 30 who wishes to receive insurance services based upon membership registration and the insurance service provider 20 communicate with each other.

As shown in FIG. 9, a person who wishes to enjoy services relating to automobile insurance provided by the insurance company (prospective insurance service using member 30) need be registered as a member in the insurance service provider 20. The person who wishes to be registered as a member in the insurance service provider 20 (applicant, or prospective insurance service using member 30) calls up the insurance service provider 20 using a terminal unit such as a PC 31, in-vehicle equipment 32 and a portable information terminal 33 in step 302. When the applicant calls up (accesses) the insurance service provider 20 in step 302, the insurance service provider 20 replies thereto and transmits a menu in return to the applicant (prospective insurance service using member 30) in step 304.

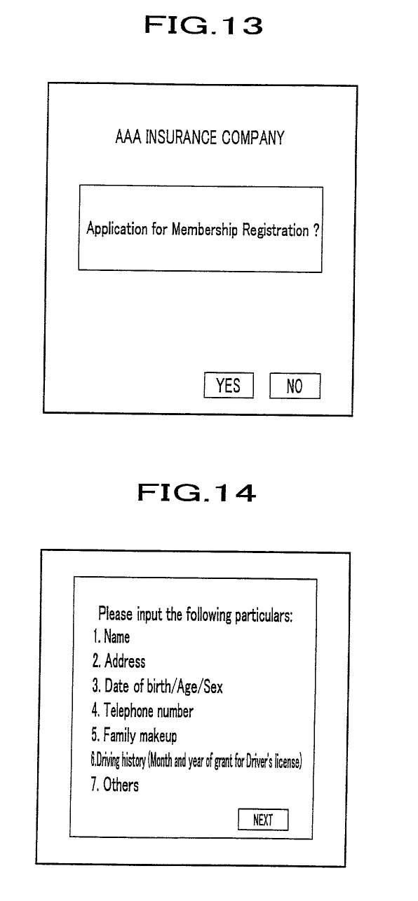

When the menu transmitted from the insurance service provider 20 is received in step 306 by the terminal unit such as the PC 31, in-vehicle equipment 32 and portable information terminal 33 of the applicant (prospective insurance service using member 30), a message “Application for Membership Registration?” appears on a screen of the terminal unit as shown in FIG. 13, prompting the applicant (prospective insurance service using member 30) to choose yes or no. If the applicant (prospective insurance service using member 30) chooses (clicks) “NO” in reply to the message as shown in FIG. 13, the process turns to another option in the menu in step 308. If “YES” is chosen (clicked) in reply to the message as shown in FIG. 13 in step 306, the applicant (prospective insurance service using member 30) proceeds to an application for membership registration to the insurance service provider 20 in step 310.

The application for membership registration by the applicant (prospective insurance service using member 30) to the insurance service provider 20 is transmitted to the insurance service provider 20. Having received the application for membership registration from the applicant (prospective insurance service using member 30), the insurance service provider 20 transmits on-screen input form data in step 312 to the applicant (prospective insurance service using member 30), to invite the applicant to input necessary data for membership registration which include a user name, address, occupation, contact address, age, sex, family makeup, driving history (the month and the year of grant for the driver's license), and other particulars such as hobbies, tastes and the bank account. As shown in FIG. 14, the on-screen input form to be filled in by the applicant for membership registration includes a message such as:

Please input the following particulars:

1. Name

2. Address

3. Date of birth/Age/Sex

4. Telephone number

5. Family makeup

6. Driving history

7. Others

In step 314, the applicant (insurance service using member 30) receives the on-screen input form data, to input the necessary data for membership registration in step 316 by filling in blanks item by item displayed in the on-screen input form, and then transmits the input data enclosed in the on-screen input form data to the insurance service provider 20.

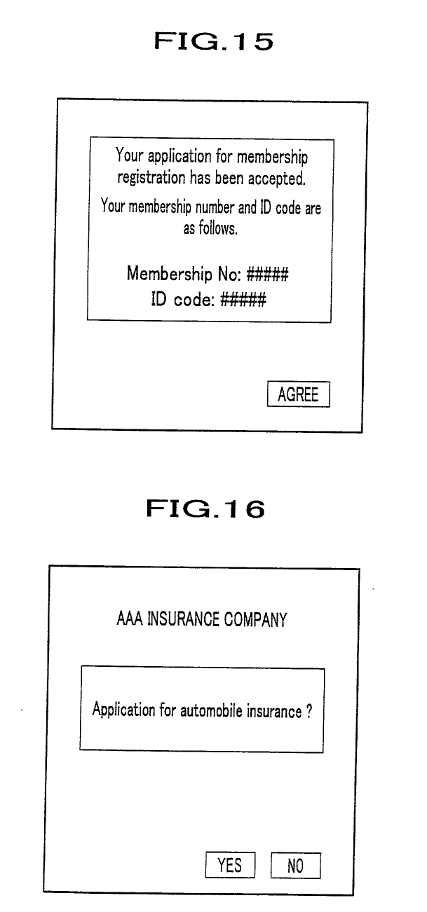

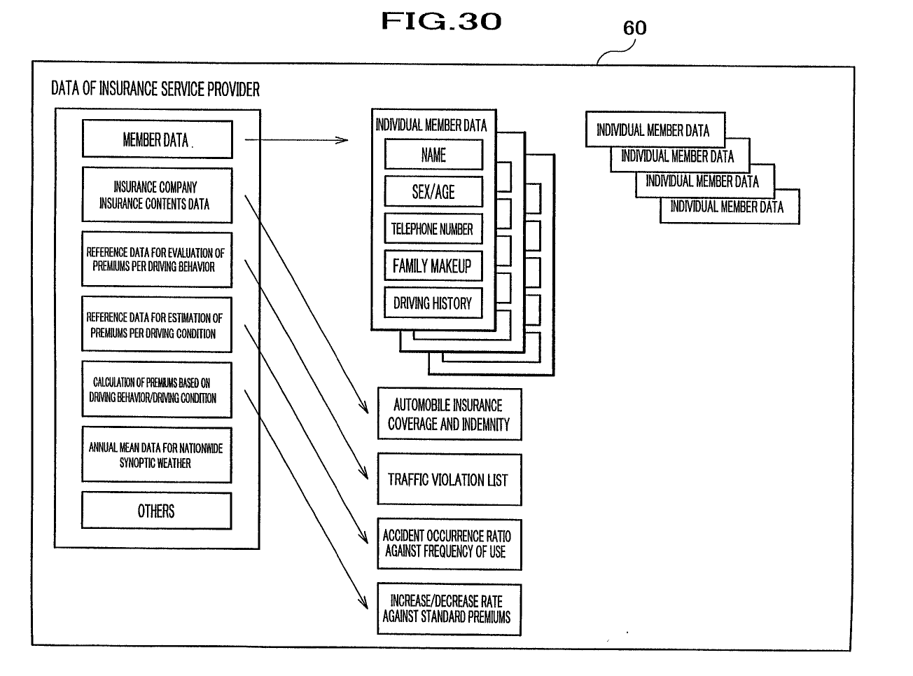

In step 318, the insurance service provider 20 receives the on-screen input form data containing the input data; then, the insurance service provider 20, in step 320, starts a membership registration process (and assigns a membership number), and creates a membership registration card 60 as illustrated in FIG. 30. Next, the insurance service provider 20 registers the applicant as a new insurance service using member in step 322 by entering the above input data required for membership registration into the membership database 71 as illustrated in FIG. 29, and allots and grants an ID code to the applicant (new insurance service using member 30). After entry of the input data and grant of the ID code, the insurance service provider 20 issues a membership registration notice in step 322 to inform the applicant (insurance service using member 30) that the applicant has been registered as a new insurance service using member. As shown in FIG. 15, the registration notice transmitted contains the following display message:

Your application for membership registration has been accepted.

Your membership number and ID code are as follows.

Membership No: #####

ID code: #####

The applicant (insurance service using member 30), who has received the registration notice transmitted from the insurance service provider 20, transmits an acknowledgment of the registration notice to the insurance service provider 20 in step 324, and the process as shown in the operation flowchart in FIG. 9 comes to an end. Completion of the series of process steps in the operation flowchart admits the applicant to be an insurance service using member in the insurance service provider 20.

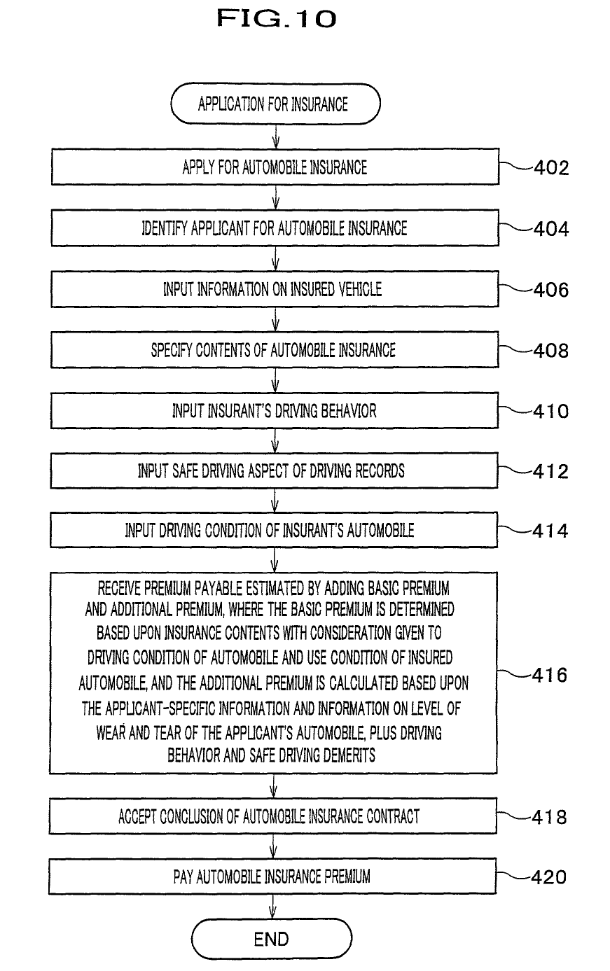

Next, a description will be given of a process performed by the insurance service using member 30 when the insurance service using member 30 buys automobile insurance based upon an application for automobile insurance to the insurance service provider 20, with reference to an operation flowchart shown in FIG. 10.

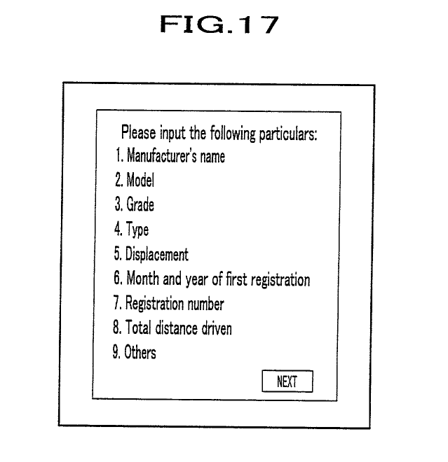

As shown in FIG. 10, when the insurance service using member 30 wishes to apply for automobile insurance offered by the insurance company 10, the insurance service using member 30 accesses the insurance service provider 20 in step 402, to submit an application for automobile insurance, through the terminal unit such as the PC 31, the in-vehicle equipment 32 and the portable information terminal 33. When the application for automobile insurance is made, the insurance service using member 30 (applicant) submits his/her membership number and ID code to allow the insurance service provider 20 to identify the applicant in step 404. The insurance service provider 20 then retrieves individual data stored in the membership database 25 based upon the submitted membership number and ID code, and confirms that the applicant is an insurance service using member. When the applicant's identification as an insurance service using member is authenticated (i.e., the application for automobile insurance is confirmed as being submitted by the member), a message containing a query as to whether the applicant wishes to make a new application for automobile insurance is transmitted from the insurance service provider 20 to the terminal unit such as the PC 31, in-vehicle equipment 32 and portable information terminal 33 of the applicant (insurance service using member 30). When the message inquiring whether or not to apply for the automobile insurance is received from the insurance service provider 20, the message “Application for automobile insurance?” is displayed as shown in FIG. 16 on the screen of the terminal unit such as the PC 31, in-vehicle equipment 32 and portable information terminal 33 of the applicant. If the applicant chooses (clicks) “YES” in reply to the query that appears with the option of yes or no as shown in FIG. 16, on-screen input form data are transmitted from the insurance service provider 20 to invite the applicant to input vehicle information on his/her automobile on which the applicant applies for the automobile insurance. As shown in FIG. 17, the on-screen input form includes a message as follows:

Please input the following particulars:

1. Manufacturer's name

2. Model

3. Grade

4. Type

5. Displacement

6. Month and year of first registration

7. Registration number

8. Total distance driven

9. Others

“Manufacturer's name” in the on-screen input form as shown in FIG. 17 indicates the name of automobile manufacturer in Japan, the U.S., France, etc. “Model” in the on-screen input form as shown in FIG. 17 indicates the name of the automobile, which is individually given by each manufacturer. “Grade” in the on-screen input form as shown in FIG. 17 indicates a rank for each model of the automobile given by each manufacturer. “Type” in the on-screen input form as shown in FIG. 17 indicates characteristics of the automobile, and for example, 4-door hardtop is included. “Displacement” in the on-screen input form as shown in FIG. 17 indicates a displacement of an engine announced for each model by each manufacturer, and for example, 3000 cc or the like is included. “Month and year of first registration” in the on-screen input form as shown in FIG. 17 indicates the month and the year when the automobile is firstly registered in the authority (e.g., the District Transportation Bureau in Japan), and for example, March 2001(H.13) is inputted. “Registration number” in the on-screen input form as shown in FIG. 17 indicates the registration number that is given upon registration, for example, in the District Transportation Bureau, and shown in the number plate, and for example, “Nerima 33 He 12-34” is inputted. “Total distance driven” in the on-screen input form as shown in FIG. 17 indicates the total distance traveled of the automobile shown in the odometer of the instrument panel. In step 406, the insurance service using member 30 inputs vehicle information according to the on-screen input form submitted from the insurance service provider 20.

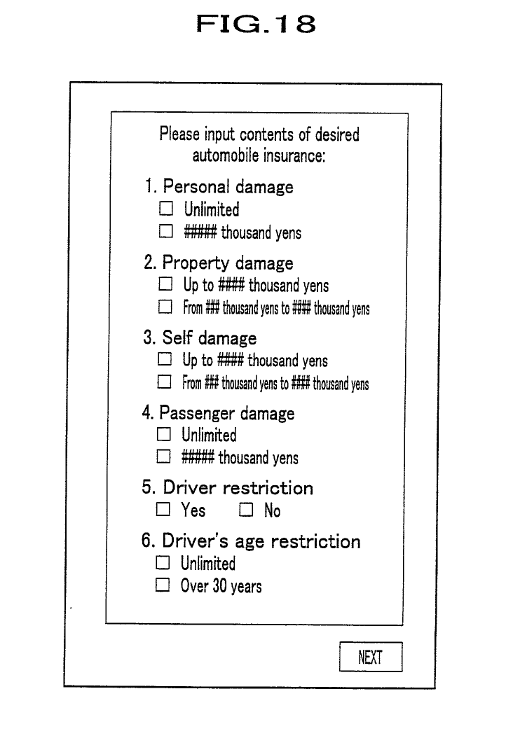

When the vehicle information is filled out in step 406, on-screen input form data are transmitted from the insurance service provider 20, to invite the insurance service using member 30 to input contents of automobile insurance for specifying a desired automobile insurance. As shown in FIG. 18, the on-screen input form includes a message as follows:

Please input contents of desired automobile insurance:

1. Personal damage

Unlimited

##### thousand yens

2. Property damage

Up to #### thousand yens

From ### thousand yens to #### thousand yens

3. Self damage

Up to #### thousand yens

From ### thousand yens to #### thousand yens

4. Passenger damage

Unlimited

##### thousand yens

5. Driver restriction

Yes

No

6. Driver's age restriction

Unlimited

Over 30 years

“Personal damage” in the on-screen input form as shown in FIG. 18 covers bodily injury of the others involved when an automobile accident happens, and an indemnity therefor may be unlimited or up to ##### thousand yens. “Property damage” in the on-screen input form as shown in FIG. 18 covers repair of the automobile of the other driver involved when an automobile accident happens, and the like, and an indemnity therefor may be up to #### thousand yens, from ### thousand to #### thousand yens, or the like. “Self damage” in the on-screen input form as shown in FIG. 18 covers repair of the insured automobile when the automobile is damaged in an automobile accident, and an indemnity therefor may be up to #### thousand yens, from ### thousand to #### thousand yens, or the like. “Passenger damage” in the on-screen input form as shown in FIG. 18 indicates coverage on passengers when the passengers are injured or dead in an automobile accident, and an indemnity therefor may be unlimited, up to ##### thousand yens, or the like. “Driver restriction” in the on-screen input form as shown in FIG. 18 specifies whether compensation is restricted to damage suffered when a specific person drives the insured automobile, and for example, the limitation on person to be indemnified may be placed to insured only. “Driver's age restriction” in the on-screen input form as shown in FIG. 18 limits age of the drivers who actually drive the insured automobile so that if a driver exceeds the age limit, the compensation is not paid for such a driver in case of an accident. For example, unlimited, over 30 years are included. The insurance service using member 30 specifies contents of the automobile insurance (coverage and indemnity) in accordance with each item in the on-screen input form as shown in FIG. 18 submitted from the insurance service provider 20 (step 408).

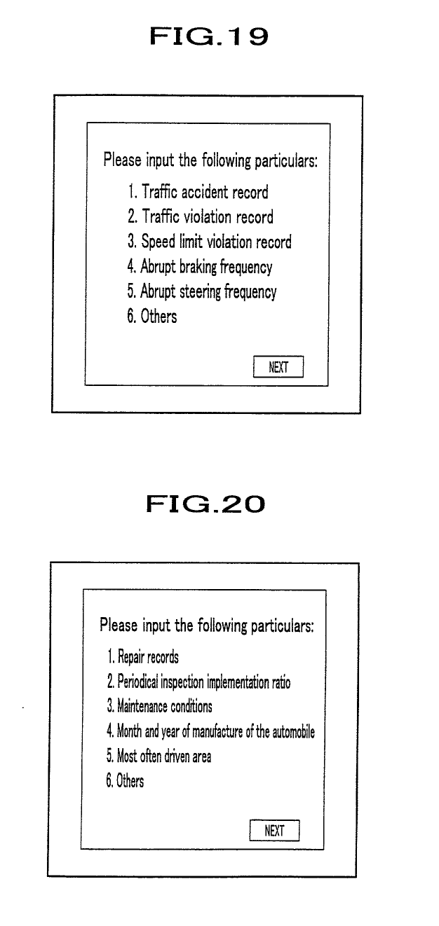

The insurance service provider 20, who has received the contents of the automobile insurance specified by the insurance service using member 30 in step 408, then transmits on-screen input form data to inquire the driving behavior of the insurance service using member 30 who has applied for the automobile insurance. As shown in FIG. 19, the on-screen input form includes a message as follows:

Please input the following particulars:

1. Traffic accident record

2. Traffic violation record

3. Speed limit violation record

4. Abrupt braking frequency

5. Abrupt steering frequency

6. Others

“Traffic accident record” in the on-screen input form as shown in FIG. 19 indicates historical traffic accident records which the applicant or the insurance service using member 30 has caused in the past, and for example, collision is included. “Traffic violation record” in the on-screen input form as shown in FIG. 19 indicates historical traffic violation records such that the applicant has violated traffic regulations in the past, and for example, punishment of the police (penalty or fine) is included. “Speed limit violation record” in the on-screen input form as shown in FIG. 19 indicates the number of times the applicant has been caught for speeding in that violating the speed limit is liable to cause a most serious accident. “Abrupt braking frequency” in the on-screen input form as shown in FIG. 19 indicates the ratio of the number of times the applicant has abruptly braked to the number of times the applicant has braked in a series of driving. Abrupt braking is an important factor in that the abrupt braking is liable to occur a serious accident. The number of times the applicant has abruptly braked and the number of times the applicant has braked may be detected by on-board brake sensors, through which the insurance service provider 20 polls and downloads information for the insured automobile. “Abrupt steering frequency” in the on-screen input form as shown in FIG. 19 indicates the number of times the applicant has used abrupt steering in a series of driving. Abrupt steering is an important factor in that the abrupt steering is liable to occur a serious accident. The number of times the applicant has used abrupt steering can be detected by a steering sensor mounted on the automobile, through which the insurance service provider 20 polls and downloads information for the insured automobile. The insurance service using member 30 inputs the driving behavior in step 410 in accordance with each item of the on-screen input form shown in FIG. 19.

Having finished inputting the driving behavior in step 410, the applicant or insurance service using member 30 then inputs his/her driving records of the insured automobile in terms of safe driving in step 412. The safe driving aspect of the driving records of the insured automobile of the applicant includes accidents, traffic violations, neglect of periodical inspections and long-sustained driving. The historical records of these particulars are inputted. Having inputted the safe driving aspect of the driving records of the insured automobile in step 412, on-screen input form data are transmitted in step 414 from the insurance service provider 20 to prompt the applicant to input a driving condition of the insured automobile. As shown in FIG. 20, the on-screen input form includes a message as follows:

Please input the following particulars:

1. Repair records

2. Periodical inspection implementation ratio

3. Maintenance conditions

4. Month and year of manufacture of the automobile

5. Most often driven area

6. Others

“Repair records” in the on-screen input form as shown in FIG. 20 indicates the number of repairs done on the insured automobile in the past, which repairs are not limited to those by traffic accident. “Periodical inspection implementation ratio” in the on-screen input form as shown in FIG. 20 indicates a ratio of the actually implemented inspections to periodical automobile inspections (including statutory inspections) with respect to the insured automobile. “Maintenance conditions” in the on-screen input form as shown in FIG. 20 indicates whether the insured automobile would possibly contain parts that should presently require repairing as a result of negligence of periodical inspection, whether wear-and tear parts have been adequately replaced during periodical inspections, and the like. “Month and year of manufacture of the automobile” in the on-screen input form as shown in FIG. 20 indicates the month and year when the insured automobile was actually manufactured. This is an important factor in that the older the date of manufacture of the automobile is, the more does the automobile deteriorate. It is to be noted that the “Month and year of manufacture of the automobile” is not the date when the insured automobile is registered in the District Transportation Bureau. “Most often driven area” in the on-screen input form shown as in FIG. 20 indicates an area in which the insured automobile principally drives. This is important in that automobiles frequenting seaside are subject to corrosion, for example. The insurance service using member 30 inputs the driving condition in step 414 in accordance with each item of the on-screen input form as shown in FIG. 20. The inquiry of the driving condition may be carried out together with the inquiry of the driving behavior as shown in FIG. 19. Alternatively, an inquiry may be made for either the driving condition or the driving behavior.

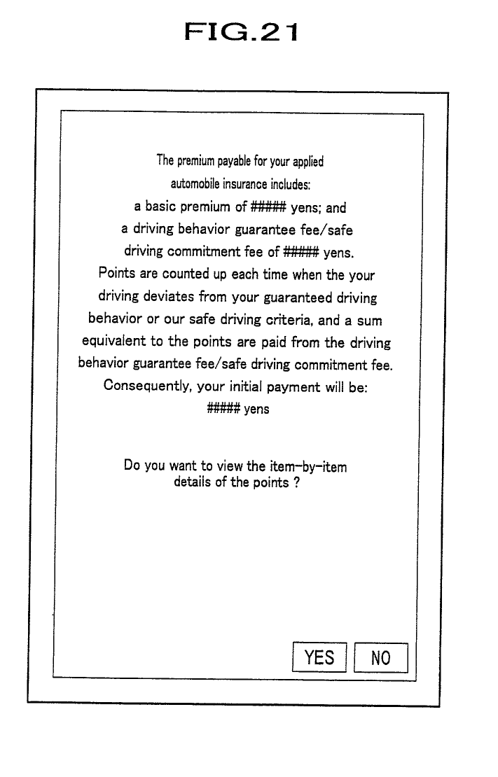

The insurance service provider 20, who has received the driving condition entered in step 414 by the insurance service using member 30, evaluates how the driving behavior, safe driving aspect and driving condition entered as above affects the existent premiums. Specifically, if it is determined that the driving behavior of the insurant is worse than the average driving behavior of insurants, the premium increases based upon an anticipation that an accident is more likely to occur. Meanwhile, if it is determined that the driving behavior of the insurant is better than the average driving behavior, the premium decreases based upon an anticipation that an accident is less likely to occur. Further, if it is determined that safe driving is kept, the premium decrease based upon an anticipation that an accident is less likely to occur. On the contrary, if it is determined that safe driving is not kept, the premium increases based upon an anticipation that an accident is more likely to occur. Likewise, if it is determined that the driving condition of the insured automobile is worth than the average driving condition of the insurants, the premium increases based upon an anticipation that an accident is more likely to occur, and if it is determined that the driving condition of the insured automobile is better than the average driving condition, the premium decreases based upon an anticipation that an accident is less likely to occur. Next the process goes to step 416. Based upon the evaluation by the insurance service provider 20, a premium payable is estimated by adding a basic premium and an additional premium, where the basic premium is determined based upon the insurance contents with consideration given to the driving condition of the automobile and the use condition of the applicant's automobile, and the additional premium is calculated based upon the applicant-specific information and information on a level of wear and tear of the applicant' automobile, plus the driving behavior and safe driving demerits. An on-screen message as shown in FIG. 21 is transmitted from the insurance service provider 20 to notify the premium payable of the automobile insurance to the insurance service using member 30 (applicant). As shown in FIG. 21, the on-screen message appears as follows:

The premium payable for your applied automobile insurance includes:

a basic premium of ##### yens; and

a driving behavior guarantee fee/safe driving commitment fee of ##### yens.

Points are counted up each time when the your driving deviates from your guaranteed driving behavior or our safe driving criteria, and a sum equivalent to the points are paid from the driving behavior guarantee fee/safe driving commitment fee. Consequently, your initial payment will be:

##### yens

Do you want to view the item-by-item details of the points?

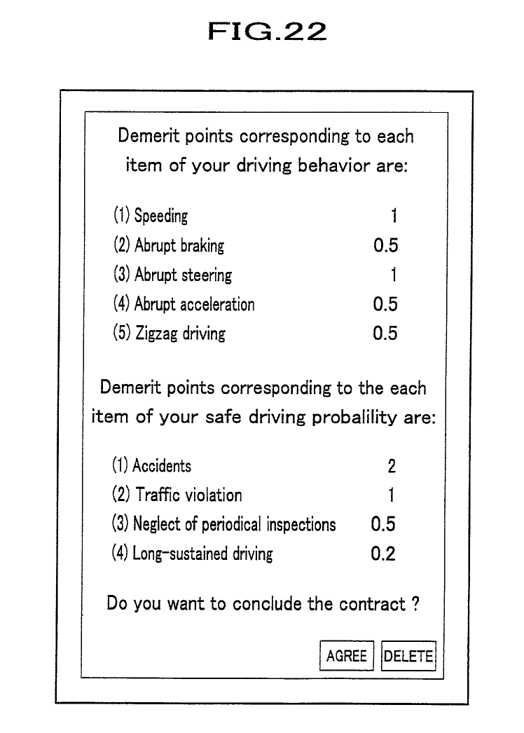

In step 416, if the applicant chooses (clicks) “YES” in reply to the on-screen message as shown in FIG. 21, another on-screen message as shown in FIG. 22 is transmitted from the insurance service provider 20 so as to notify the details of the points for each particular with which the additional premium of the premium payable is estimated. As shown in FIG. 22, the on-screen message is displayed as follows:

Demerit points corresponding to each item of your driving behavior are:

| | |
|---|---|
| (1) Speeding | 1 |
| (2) Abrupt braking | 0.5 |
| (3) Abrupt steering | 1 |
| (4) Abrupt acceleration | 0.5 |
| (5) Zigzag driving | 0.5 |

Demerit points corresponding to the each item of your safe driving probability are:

| | |
|---|---|
| (1) Accidents | 2 |
| (2) Traffic violation | 1 |
| (3) Neglect of periodical inspections | 0.5 |
| (4) Long-sustained driving | 0.2 |

Do you want to conclude the contract?

If the applicant chooses (clicks) “AGREE” in the on-screen message as shown in FIG. 22, an acknowledgment of receipt of the conclusion of the automobile insurance contract is transmitted from the insurance service provider 20 in step 418.

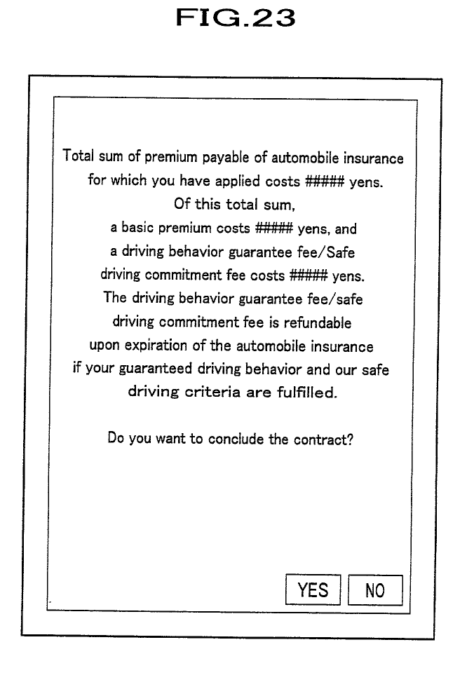

In the example as shown in FIG. 21, the total sum of the premium payable of the applied automobile insurance contains the basic premium and the driving behavior guarantee fee/safe driving commitment fee, and each time upon deviation from the applicant's guaranteed driving behavior and/or the specific safe driving criteria, some points are counted up and the amount of money corresponding to the total points is withdrawn from the driving behavior guarantee fee/safe driving commitment fee. However, in another example as shown in FIG. 23, alternative on-screen input form data may be transmitted from the insurance service provider 20 in step 416 to notify the premium payable of the automobile insurance to the insurance service using member 30. As shown in FIG. 23, the on-screen message appears as follows:

Total sum of premium payable of automobile insurance for which you have applied costs ##### yens.

Of this total sum,

a basic premium costs ##### yens, and

a driving behavior guarantee fee/Safe driving commitment fee costs ##### yens.

The driving behavior guarantee fee/safe driving commitment fee is refundable upon expiration of the automobile insurance if your guaranteed driving behavior and our safe driving criteria are fulfilled.

Do you want to conclude the contract?

In this example, payment based upon the driving behavior and the safe driving are not made by point, but the driving behavior guarantee fee/safe driving commitment fee is refunded as the privilege of warrant when the driving behavior and the safe driving are kept.

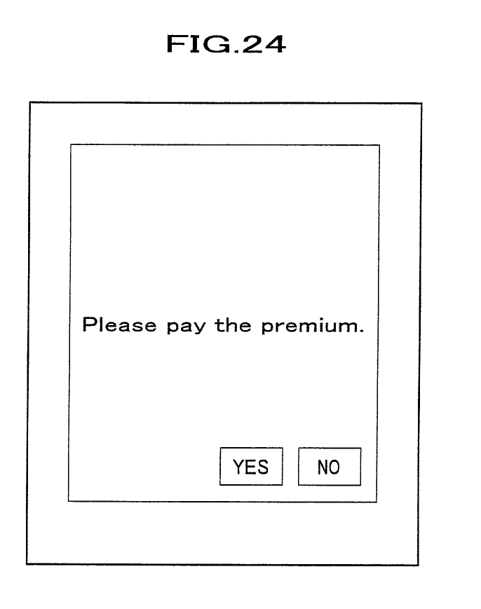

The insurance service provider 20, who has received acknowledgment of receipt of the conclusion of the insurance contract containing a specific premium amounts in step 418, transmits an on-screen message as shown in FIG. 24 to the applicant to demand the payment of the premium payable for the automobile insurance. The message appears on the screen as follows:

Please pay the premium.

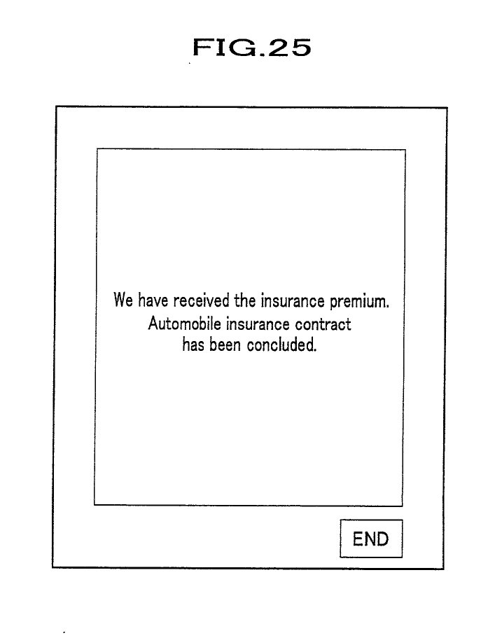

In step 418, if the applicant chooses (clicks) “YES” in the on-screen message as shown in FIG. 24, the automobile insurance contract is concluded. The insurance service using member 30 owes a duty for payment of the automobile insurance premium by choosing (clicking) “YES” in the on-screen message. When the insurance service using member 30 completes the payment of the thus-demanded premium payable with respect to the insurance service provider 20 in step 420, an on-screen message as shown in FIG. 25 is transmitted from the insurance service provider 20 to notify the applicant of the conclusion of the automobile insurance, thereafter completing the flow. As shown in FIG. 25, the on-screen message is as follows.

We have received the insurance premium.

Automobile insurance contract has been concluded.

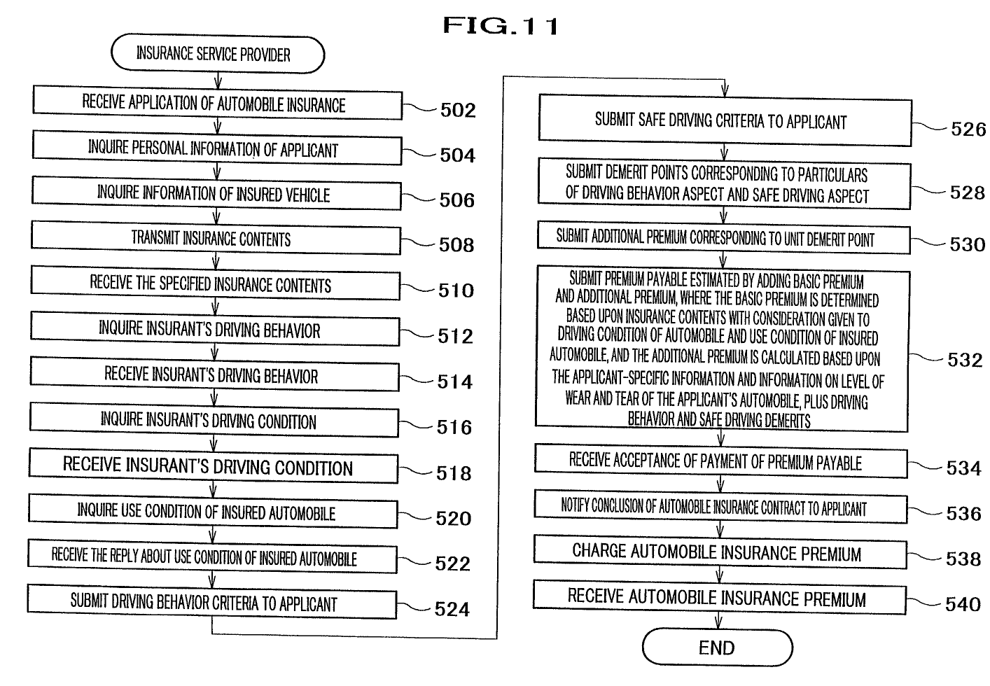

Next, an operation flow of a process performed by the insurance service provider 20 when an application of the automobile insurance is made will be described with reference to FIG. 11.

As shown in FIG. 11, when the insurance service using member 30 wishes to apply for the automobile insurance offered by the insurance company 10, in step 502, the insurance service provider 20 receives an application from the insurance service using member 30. The insurance service provider 20, which receives the application from the insurance service using member 30 in step 502, inquires personal information of the applicant such as the membership number, the ID code, etc. in order to specify the applicant for the automobile insurance. When the personal information is submitted by the applicant, the insurance service provider 20 retrieves a personal data of the insurance service using member 30 from the membership database 71 which includes personal data of the insurance service using members 30 as shown in FIG. 29 on the basis of the personal information. Accordingly, the applicant is authenticated as an insurance service using member, and then the personal data of the insurance service using member 30 are located.

When the applicant is confirmed as the insurance service using member (i.e., the application for automobile insurance is confirmed as being submitted by the member), a message containing a query such as “Application for automobile insurance?” is transmitted from the insurance service provider 20 to the insurance service using member 30. If the insurance service using member 30 chooses (clicks) “YES” in the on-screen message as shown in FIG. 16, the insurance service provider 20 inquires, in step 506, information with regard to the insured vehicle by sending an on-screen input form as illustrated in FIG. 17 to invite the applicant to input vehicle information on the insured vehicle. When the insurance service using member 30 inputs the vehicle information into the on screen input form as shown in FIG. 17 and the insurance service provider 20 receives input data on the vehicle information, the insurance service provider 20, in step 508, transmits the insurance service using member 30 an on-screen input form as shown in FIG. 18 to invite the applicant to input contents of the automobile insurance to specify the desired automobile insurance. When the insurance service using member 30 inputs the contents of the automobile insurance in response to the queries in the on-screen input form as shown in FIG. 18, the insurance service provider 20 receives an input result from the insurance service using member 30 in step 510.

Having received the input result of the contents of the automobile insurance in step 510, the insurance service provider 20 transmits the insurance service using member 30 an on-screen input form as shown in FIG. 19 for inquiring the driving behavior of the insurance service using member 30 in step 512. When the insurance service using member 30 inputs the driving behavior in response to the queries the on-screen input form as shown in FIG. 19, the insurance service provider 20 receives an input result of the driving behavior from the insurance service using member 30 in step 514. Having received the input result of the driving behavior in step 514, in step 516, the insurance service provider 20 transmits the insurance service using member 30 an on-screen input form as shown in FIG. 20 for inquiring the driving condition of the insurance service using member's automobile. When the insurance service using member 30 inputs the driving condition in response to the queries in the on-screen input form as shown in FIG. 20, the insurance service provider 20 receives an input result of the driving condition from the insurance service using member 30 in step 518.

Having received the input result of the driving condition in step 518, inquiry of the use condition of the insured vehicle (use years, total distance traveled, replacement of parts, etc.) is carried out in step 520. When the insurance service using member 30 replies the use condition of the insured automobile in response to the queries about the use condition of the insured automobile in step 520, the insurance service provider 20 receives the reply about the use condition of the insured automobile from the insurance service using member 30 in step 522. Having received the reply about the use condition of the insured automobile in step 522, the insurance service provider 20 submits driving behavior criteria (the driving behavior submitted by the applicant, and specifically the particulars as shown in FIG. 19) to the applicant of the automobile insurance (insurance service using member 30) in step 524. Furthermore, in step 526, the insurance service provider 20 submits safe driving criteria (accidents, traffic violations, neglect of periodical inspections, and long-sustained driving) to the applicant of the automobile insurance (insurance service using member 30). Having submitted the driving behavior criteria in step 524 and the safe diving criteria in step 526 to the applicant of the automobile insurance (insurance service using member 30), the insurance service provider 20, in step 528, submits demerit points corresponding to the particulars of the driving behavior criteria and demerit points corresponding to the particulars of the safe driving criteria (see FIG. 22 for the specifics) to the applicant of the automobile insurance (insurance service using member 30). Furthermore, in step 530, the insurance service provider 20 submits an additional premium corresponding to a unit demerit point (for example, 0.1 point/## yens) with respect to the demerit points of each particular of the driving behavior and safe driving criteria to the applicant of the automobile insurance (insurance service using member 30).

Having submitted the additional premium corresponding to the unit demerit point to the applicant of the automobile insurance (insurance service using member 30) in step 530, the insurance service provider 20 evaluates how the driving behavior, the use condition of the insured automobile and the safe driving aspect submitted by the applicant (insurance service using member 30) affects the existing premium. Based upon the evaluation, in step 532, the insurance service provider 20 calculates the premium payable by adding a basic premium and an additional premium, where the basic premium is determined based upon the insurance contents with consideration given to the driving condition of the automobile and the use condition of the applicant's automobile, and the additional premium is calculated based upon the applicant-specific information and information on a level of wear and tear of the applicant' automobile, plus the driving behavior and safe driving demerits. An on-screen message as shown in FIG. 21 is transmitted from the insurance service provider 20 to notify the premium payable of the automobile insurance to the applicant (insurance service using member 30). If the applicant (insurance service using member 30) accepts the amount of the premium payable for the automobile insurance, viz. the applicant chooses (clicks) “YES” in the on-screen message as shown in FIG. 21 in response to the on-screen message, the insurance service provider 20 receives the acceptance of the premium payable from the applicant (insurance service using member 30) in step 534. Having received the acceptance of the premium payable from the applicant (insurance service using member 30) in step 534, the insurance service provider 20, in step 536, notifies the conclusion of the automobile insurance to the applicant (insurance service using member 30), and transmits an on-screen message as shown in FIG. 24 in step 538 to demand the payment of the premium payable for the automobile insurance. When the insurance service using member 30, who has received the on-screen message as in FIG. 24, accepts payment of the automobile insurance premium and pays for the automobile insurance premium, and the insurance service provider 20 receives the payment of the automobile insurance premium, a notification of the receipt of the premium payment is transmitted in step 540 to the insurance service using member 30 and the flow is completed.

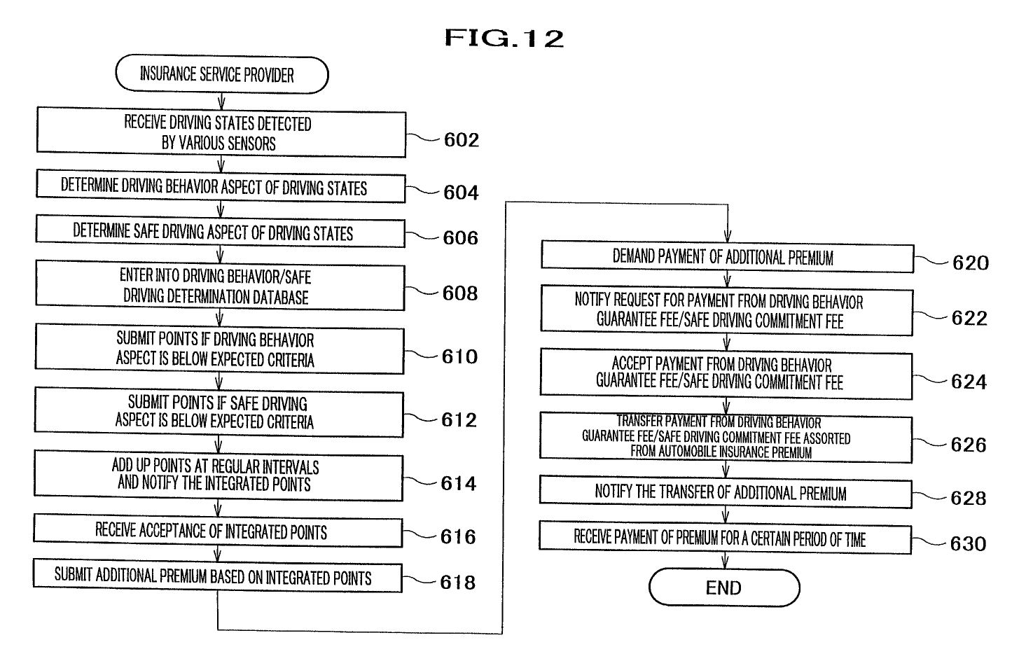

Next, with reference to FIG. 12, the operation flow of the insurance service provider 20 for collecting the automobile insurance premium after concluding the contract of the automobile insurance with the insurance service using member 30 will be described.

As shown in FIG. 12, before collecting the premium payable for automobile insurance concluded with the insurance service using member 30, in step 602, the insurance service provider 20 receives from the insurance service using member 30 (in-vehicle equipment 40) the driving condition of the automobile detected by sensors 47 of the in-vehicle equipment 40 (e.g., a speed sensor, a vehicle speed sensor, a rainfall sensor, an illumination sensor, an engine temperature sensor, an engine revolution sensor, a headlight/fog detector lamp lighting sensor, a room temperature sensor, etc.). Having received the driving condition detected by the sensors 47 in step 602, the insurance service provider 20 determines the driving behavior in step 604 and the safe driving aspect of driving states in step 606 on the basis of the detected data from the sensors 47. The determination results of the driving behavior in step 604 and the safe driving aspect of driving states in step 606 are entered in step 608 into the driving behavior/safe driving determination database 76 of the insurance service provider 20 in a storage device of the processor 21. If the determination result of the driving behavior stored in step 606 in the driving behavior/safe driving determination database 76 is lower than the criterion, in step 610, the insurance service provider 20 submits points to be added or deducted to the insurance service using member 30 (in-vehicle equipment 40). Furthermore, if the determination result of the safe driving aspect of driving states stored in step 606 in the driving behavior/safe driving determination database 76 is lower than the criterion, in step 612, the insurance service provider 20 submits points to be added or deducted to the insurance service using member 30 (in-vehicle equipment 40).

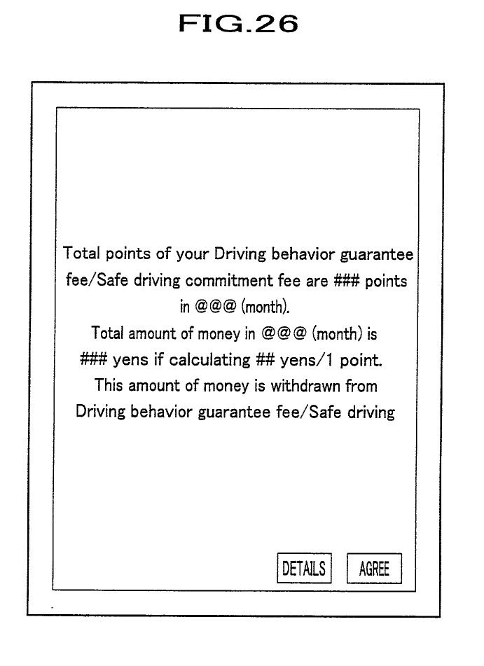

The points submitted to the insurance service using member 30 (in-vehicle equipment 40) are calculated periodically (for example, every month, every three months, etc.), and in step 612, an on-screen message as shown in FIG. 26 is transmitted from the insurance service provider 20 to the insurance service using member 30 (in-vehicle equipment 40) to notify the total points for calculating the additional premium of the premium payable for the automobile insurance and the amount of money corresponding to the total points. As shown in FIG. 26, the on-screen message is as follows.

Total points of your Driving behavior guarantee fee/Safe driving commitment fee are ### points in @@@ (month).

Total amount of money in @@@ (month) is ### yens if calculating ## yens/1 point. This amount of money is withdrawn from driving behavior guarantee fee/Safe driving commitment fee.

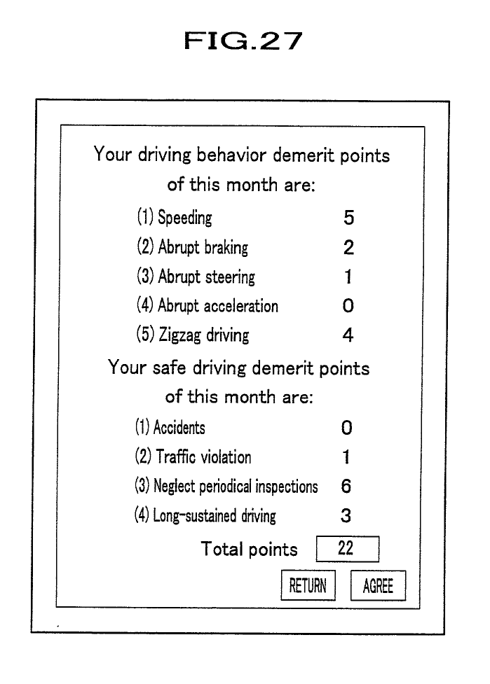

If details of the demerit points are required, the insurance service using member 30 chooses (clicks) “DETAILS” in the on-screen message as shown in FIG. 26. If the insurance service using member 30 chooses (clicks) “DETAILS” in the on-screen message as shown in FIG. 26, an on-screen message as shown in FIG. 27 is transmitted from the insurance service provider 20 to the insurance service using member 30 (in-vehicle equipment 40) for indicating the total points for calculating the additional premium of the premium payable for the automobile insurance. As shown in FIG. 27, the on-screen message is as follows.

Your driving behavior demerit points of this month are:

| | |
|---|---|
| (1) Speeding | 5 |
| (2) Abrupt braking | 2 |
| (3) Abrupt steering | 1 |
| (4) Abrupt acceleration | 0 |
| (5) Zigzag driving | 4 |

Your safe driving demerit points of this month are:

| | |
|---|---|
| (1) Accidents | 0 |
| (2) Traffic violation | 1 |
| (3) Neglect of periodical inspections | 6 |
| (4) Long-sustained driving | 3 |
| Total points | 22 |

If the insurance service using member 30 chooses (clicks) “RETURN” in reply to the on-screen message as in FIG. 27, then the process returns to the on-screen message as shown in FIG. 26. If the insurance service using member 30 chooses (clicks) “AGREE” in the on-screen message as in FIG. 27, agreement of the insurance service using member 30 (through in-vehicle equipment 40) about the demerit points submitted by the insurance service provider 20 is transmitted to the insurance service provider 20. In step 616, the insurance service provider 20 receives the agreement of the demerit points.

After receiving the agreement of the demerit points in step 616, the insurance service provider 20, in step 618, submits the additional premium on the basis of the integrated points to be integrated periodically (for example, one month, three months, etc.) to the insurance service using member 30 (in-vehicle equipment 40). In step 620, the insurance service provider 20 demands payment of the additional premium to the insurance service using member 30 (in-vehicle equipment 40). Upon demanding the payment of the additional premium in step 620, the insurance service provider 20 notifies the insurance service using member 30 (in-vehicle equipment 40) in step 622 that the additional premium is withdrawn from the driving behavior guarantee fee/safe driving commitment fee. If the insurance service provider 20 notifies in step 622 the insurance service using member 30 that the additional premium will be withdrawn from the driving behavior guarantee fee/safe driving commitment fee, and the insurance service using member 30 (in-vehicle equipment 40) agrees to the withdrawal, in step 624, then the insurance service provider 20 receives the agreement from the insurance service using member 30 (in-vehicle equipment 40).

Having received the agreement from the insurance service using member 30 (in-vehicle equipment 40) in step 624, the insurance service provider 20 withdraws the additional premium from the driving behavior guarantee fee/safe driving commitment fee of the premium payable in step 626, which additional premium paid by the insurance service using member 30 is divided into the basic premium and the driving behavior guarantee fee/safe driving commitment fee. Upon withdrawal of the additional premium from the driving behavior guarantee fee/safe driving commitment fee in step 626, the insurance service provider 20 notifies the insurance service using member 30 (in-vehicle equipment 40) in step 628 that the additional premium has been withdrawn from the driving behavior guarantee fee/safe driving commitment fee. Having notified the withdrawal of the additional premium from the driving behavior guarantee fee/safe driving commitment fee in step 628, the insurance service provider 20, in step 630, receives payment of the premium (premium payable) for a certain period of time (for example, one month, three months, etc.), and completes the operation flow.

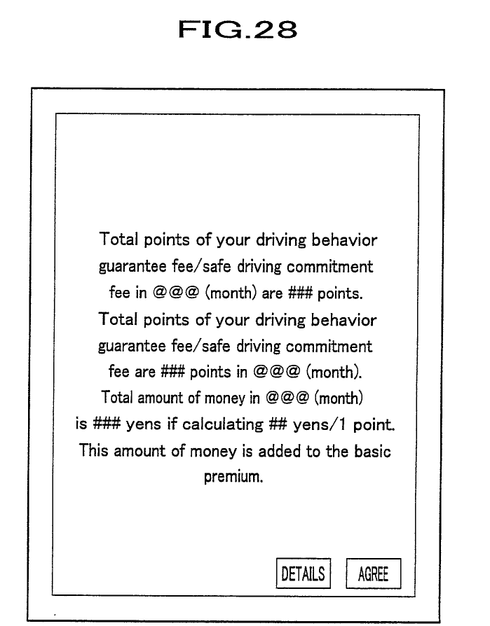

With reference to the flowchart shown in FIG. 12, in the on-screen message for executing step 612 and indicating the total points for calculating the additional premium of the premium payable for the automobile insurance and the amount of money corresponding to the total points, the amount of money corresponding to the total points is withdrawn from the driving behavior guarantee fee/safe driving commitment fee. However, as shown in FIG. 28, an alternative on-screen message may be transmitted from the insurance service provider 20 to notify the total points for calculating the additional premium of the premium payable for the automobile insurance and the amount of money corresponding to the total points. As shown in FIG. 28, the on-screen message is as follows.

Total points of your driving behavior guarantee fee/safe driving commitment fee in @@@ (month) is ### points.

Total amount of money in @@@ (month) is ### yens if calculating ## yens/1 point. This amount of money is added to the basic premium.

In the on-screen message as shown in FIG. 28, points concerning the driving behavior and safe driving criteria are added to the basic premium. Likewise the message screen of FIG. 26, if details of the demerit points are required, the insurance service using member 30 chooses (clicks) “DETAILS” in the message screen shown in FIG. 28. In this event, the message screen shown in FIG. 27 appears. Operations of the following steps 614 to 630 are the same as those described above.

The foregoing description of the preferred embodiments of the invention has been presented to illustrate the principles of the invention and not to limit the invention to the particular embodiments illustrated. It is intended that the scope of the invention be defined by all of the embodiments encompassed within the following claims, and equivalents thereof.

What is claimed is:

1. An automobile insurance contents setting system that is configured to:
request an insurant to submit his/her driving behavior, based upon an application for automobile insurance for which the insurant has specified coverage and indemnity;
evaluate the driving behavior submitted by the insurant; and
calculate a premium of the automobile insurance in accordance with the evaluated driving behavior of the insurant.

2. An automobile insurance contents setting system that is configured to perform the steps of:
entering insurance contents into an insurant database, based upon an application for automobile insurance for which an insurant has specified coverage and indemnity;
requesting the insurant to submit his/her driving behavior;
receiving and entering into the insurant database the driving behavior of the insurant submitted by the insurant;
making an evaluation of the driving behavior of the insurant;
entering the evaluation of the driving behavior of the insurant into the insurant database;
calculating and entering into the insurant database a premium of the automobile insurance in accordance with the evaluation of the driving behavior of the insurant;
submitting the calculated premium to the insurant;
charging the premium in the insurant database to the insurant, based upon the application for automobile insurance; and
entering a conclusion of a contract of the automobile insurance into the insurant database based upon payment of the premium by the insurant.

3. An automobile insurance contents setting system according to claim 1, wherein the driving behavior of the insurant to be submitted by the insurant includes a driving history of the insurant.

4. An automobile insurance contents setting system according to claim 1, wherein the driving behavior of the insurant to be submitted by the insurant includes a traffic violation record of the insurant.

5. An automobile insurance contents setting system according to claim 1, wherein the driving behavior of the insurant to be submitted by the insurant includes a traffic accident record of the insurant.

6. An automobile insurance contents setting system according to claim 1, wherein the driving behavior of the insurant to be submitted by the insurant includes a total distance driven by the insurant.

7. An automobile insurance contents setting system that is configured to:
request an insurant to submit his/her driving condition, in response to an application for automobile insurance for which the insurant has specified coverage and indemnity;
evaluate the driving condition submitted by the insurant, based upon the application for automobile insurance; and
calculate a premium of the automobile insurance in accordance with the evaluated driving condition of the insurant.

8. An automobile insurance contents setting system that is configured to perform the steps of:
entering insurance contents into an insurant database, based upon an application for automobile insurance for which an insurant has specified coverage and indemnity;
requesting the insurant to submit his/her driving condition;
receiving and entering into the insurant database the driving condition of the insurant submitted by the insurant;
making an evaluation of the driving condition of the insurant;
entering the evaluation of the driving condition of the insurant into the insurant database;
calculating and entering into the insurant database a premium of the automobile insurance in accordance with the evaluation of the driving condition of the insurant;
submitting the calculated premium to the insurant;
charging the premium in the insurant database to the insurant, based upon the application for automobile insurance; and
entering a conclusion of a contract of the automobile insurance into the insurant database based upon payment of the premium by the insurant.

9. An automobile insurance contents setting system according to claim 7, wherein the driving condition of the insurant to be submitted by the insurant includes a limited time of day to the night hours during which the insurant drives an automobile.

10. An automobile insurance contents setting system according to claim 7, wherein the driving condition of the insurant to be submitted by the insurant includes a level of maintenance conditions of an automobile of the insurant.

11. An automobile insurance contents setting system according to claim 7, wherein the driving condition of the insurant to be submitted by the insurant includes the number of occurrences of engine trouble of an automobile of the insurant.

12. An automobile insurance contents setting system according to claim 7, wherein the driving condition of the insurant to be submitted by the insurant includes the number of repairs of an automobile of the insurant.

13. An automobile insurance contents setting system according to claim 7, wherein the driving condition of the insurant to be submitted by the insurant includes an area in which the insurant principally drives an automobile.

14. An automobile insurance contents setting system according to claim 7, wherein the driving condition of the insurant to be submitted by the insurant includes a dedicated use of an automobile to commutation to and from work.

15. An automobile insurance premium setting system that is configured to:
calculate a basic premium, based upon an application for automobile insurance for which an insurant has specified coverage and indemnity, the basic premium being invariably determined in accordance with the indemnity of the automobile insurance;
request the insurant to submit his/her driving behavior;
estimate an additional premium based upon the driving behavior submitted by the insurant;
provisionally collect a premium payable calculated by adding the basic premium and the additional premium;
determine driving behavior points and safe driving points, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and
combine the driving behavior points and the safe driving points into demerit points to calculate an actual additional premium corresponding to the demerit points, and balance a difference between the estimated additional premium and the actual additional premium upon expiration of the automobile insurance.

16. An automobile insurance premium setting system that is configured to perform the steps of:
entering insurance contents into an insurant database, based upon an application for automobile insurance for which an insurant has specified coverage and indemnity by selecting among coverages and indemnities stored in an automobile insurance contents database;
calculating and entering into the insurant database a basic insurance premium that is invariably determined in accordance with the indemnity of the automobile insurance;
estimating and entering into the insurant database an additional premium based upon driving behavior submitted by the insurant;
provisionally collecting a premium payable calculated by adding the basic premium and the additional premium, and entering the premium payable into a premium payment database;
determining driving behavior points and safe driving points in accordance with determination criteria stored in a driving behavior/safe driving determination database and entering the driving behavior points and safe driving points into the insurant database, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and
combining the driving behavior points and the safe driving points into demerit points to calculate an actual additional premium corresponding to the demerit points, and entering the actual additional premium into the insurant database to balance a difference between the estimated additional premium and the actual additional premium upon expiration of the automobile insurance.

17. An automobile insurance premium setting system that is configured to:
calculate a basic premium, based upon an application for automobile insurance for which an insurant has specified coverage and indemnity, the basic premium being invariably determined in accordance with the indemnity of the automobile insurance;
request the insurant to submit his/her driving behavior;
estimate an additional premium based upon the driving behavior submitted by the insurant;
collect a premium payable calculated by adding the additional premium as a deposit to the basic premium;
determine driving behavior points and safe driving points periodically, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and
combine the driving behavior points and the safe driving points into demerit points to calculate an actual additional premium corresponding to the demerit points, and subtract the actual additional premium from the estimated additional premium periodically.

18. An automobile insurance premium setting system that is configured to perform the steps of:
entering insurance contents into an insurant database, based upon an application for automobile insurance for which an insurant has specified coverage and indemnity by selecting among coverages and indemnities stored in an automobile insurance contents database;
calculating and entering into the insurant database a basic insurance premium that is invariably determined in accordance with the indemnity of the automobile insurance;
estimating and entering into the insurant database an additional premium based upon the driving behavior submitted by the insurant;
collecting a premium payable calculated by adding the additional premium as a deposit to the basic premium, and entering the premium payable into a premium payment database;
determining driving behavior points and safe driving points periodically in accordance with determination criteria stored in a driving behavior/safe driving determination database and entering the driving behavior points and safe driving points into the insurant database, the driving behavior points being counted each time when actual driving behavior of the insurant deviates from criteria determined based upon the driving behavior submitted by the insurant, and the safe driving points being counted each time when the actual driving behavior of the insurant deviates from safe driving criteria submitted to the insurant in advance; and
combining the driving behavior points and the safe driving points into demerit points periodically to calculate an actual additional premium corresponding to the demerit points, and entering the actual additional premium into the insurant database.

19. An automobile insurance premium setting system according to claim 15, wherein the driving behavior points concern speeding, abrupt braking, abrupt steering, abrupt acceleration, and zigzagging.

20. An automobile insurance premium setting system according to claim 15, wherein the safe driving points concern traffic accidents, traffic violations, neglecting periodical automobile inspections, and long-sustained driving.

21. An automobile insurance premium collection system that is configured to:
collect a premium payable estimated by adding a basic premium and an additional premium, the basic premium being determined from coverage and indemnity that have been specified by an insurant, and the additional premium being determined based upon driving behavior submitted by the insurant in advance;
add a first premium incurred if actual driving behavior of the insurant deviates from driving behavior criteria determined based upon the driving behavior specified by the insurant and a second premium incurred if the actual driving behavior of the insurant deviates from safe driving criteria submitted to the insurant in advance; and
add the first and second premiums as an actual additional premium to the basic premium to obtain an actual premium payable, balancing a difference between the estimated premium payable and the actual premium payable, upon expiration of the automobile insurance.

22. An automobile insurance premium setting system that is configured to:
collect a basic premium determined based upon coverage and indemnity of insurance that have been specified by an insurant;
estimate an additional premium based upon driving behavior of the insurant submitted by the insurant;
collect the additional premium as a deposit;
add a first premium incurred if actual driving behavior of the insurant deviates from driving behavior criteria determined based upon the driving behavior specified by the insurant and a second premium incurred if the actual driving behavior of the insurant deviates from safe driving criteria submitted to the insurant in advance; and
periodically collect the first and second premiums from the additional premium collected as a deposit.

23. An automobile insurance premium setting system that is configured to:
collect a basic premium determined based upon coverage and indemnity of insurance that have been specified by an insurant;
estimate an additional premium based upon driving behavior of the insurant submitted by the insurant in advance;
collect the additional premium as a deposit; and
grant safety driving points if actual driving behavior of the insurant fulfills driving behavior criteria determined based upon the driving behavior submitted by the insurant in advance and if the actual driving behavior of the insurant fulfills safe driving criteria submitted to the insurant in advance.
